(19) United States
(12) Patent Application Publication
(10) Pub. No.: US 2006/0068895 A1
(43) Pub. Date: Mar. 30, 2006

(54) Apparatus for pre-determined game outcomes

(76) Inventors: Binh T. Nguyen, Reno, NV (US); James Stockdale, Clio, CA (US); Craig A. Paulsen, Reno, NV (US); David Muir, Newcastle (AU)

Correspondence Address: BEYER WEAVER & THOMAS LLP, P.O. BOX 70250, OAKLAND, CA, 94612-0250, US

(21) Appl. No.: 10/937,989

(22) Filed: Sep. 10, 2004

(51) Int. Cl. A63F 13/00

(52) U.S. Cl. 463/25

(57) ABSTRACT

A portable memory apparatus may include a player identification and game outcomes associated with the player identification. The portable memory apparatus may communicatively couple with a gaming apparatus, provide a game outcome to the gaming apparatus, and communicatively decouple from the gaming apparatus. A gaming apparatus may include a display unit, an input device and a controller operatively coupled to the display unit and the input device. The controller may be programmed to cause the input device to read game outcome data stored in a portable memory, to determine an outcome based on the game outcome data, to display the outcome on the display unit, to determine if the outcome is a winning outcome, to determine a value payout if the outcome is a winning outcome, and to cause the input device to update the portable memory with data relating to the outcome or the value payout.

### BACKGROUND

This patent is directed to a casino gaming apparatus involving pre-purchased game outcomes, which could be used with either an individual gaming unit or a casino gaming system.

A gaming apparatus of the type used in casinos has included a display unit such as a video display unit or a set of mechanical slot machine reels, a value input device such as a coin slot or paper currency reader, and a controller operatively coupled to the display unit and the value input device and having a processor and a memory operatively coupled to the processor. The controller was programmed to control the overall functions of the gaming machine, including generating game displays representing one or more of a number of casino games, such as poker, blackjack, slots, keno or bingo.

U.S. Pat. No. 6,502,116 to Kelly et al. discloses a random number generator seeding method and apparatus. A random number generator is seeded and a gaming apparatus is made available to multiple players to commence game play with the gaming apparatus. U.S. Pat. No. 6,533,664 to Crumby discloses a gaming system with individualized, centrally-generated random number generator seeds. Gaming terminals having gaming outcomes are provided in response to a game outcome seed sent from a central computer. Not all gaming terminals use the same seed at the same time. The seeds are addressed to individual gaming terminals or groups of terminals.

U.S. Patent Application Publication No. 2003/0162591 to Nguyen et al. discloses a method and gaming machine/system that provides security to cashless gaming instruments by placing authentication data on a ticket. Player authentication data is placed on a cashless instrument that may later be read and authenticated. U.S. Pat. No. 6,729,961 to Millerschone discloses a method for displaying an interactive game having a pre-determined outcome. U.S. Patent Application Publication No. 2003/0144053 to Michaelson discloses a gaming method that receives a value amount and deducts a fee at intervals from the value amount. The deduction of the fee is independent of game play.

### SUMMARY OF THE INVENTION

In one aspect, the invention is directed to a gaming system that may include a portable memory apparatus and a plurality of gaming apparatuses. The portable memory apparatus may have a plurality of seed values associated with a player identification stored thereon. Each of the seed values may relate to an outcome of a game play. Each of the gaming apparatuses may include an input device for receiving and reading the portable memory, a display unit and a controller operatively coupled to the display unit and the input device. Each of the controllers may be programmed to read a seed value from the portable memory apparatus, to cause the display unit to generate a game display, to determine an outcome of the game based on the seed value, and to determine a value payout associated with the outcome of the game. The game display may relate to poker, blackjack, slots, keno or bingo.

In another aspect, the invention is directed to a gaming apparatus for determining outcomes of a wagering game based on game outcome data stored in a portable memory device. The gaming apparatus may include a display unit, an input device configured to communicatively couple to a portable memory device and a controller operatively coupled to the display unit and the input device. The controller may include a processor and a memory operatively coupled to the processor. The controller may be programmed to cause the input device to read game outcome data stored in a portable memory device, to determine an outcome based on the game outcome data, to display the outcome on said display unit, to determine if the outcome is a winning outcome, to determine a value payout if the outcome is a winning outcome, and to cause the input device to update the portable memory device with data relating to the outcome or the value payout. The game display may relate to poker, blackjack, slots, keno or bingo.

In a further aspect, the invention is directed to a portable memory apparatus which may include a computer program stored therein. The computer program may be capable of being used in connection with a plurality of gaming apparatuses. The memory may include a memory portion having identification data relating to a player identification, a memory portion having a plurality of game outcomes associated with the player identification, a memory portion having game outcome data relating to a plurality of game outcomes associated with the player identification, a memory portion physically configured in accordance with computer program instructions that would cause the portable memory apparatus to communicatively couple with a gaming apparatus, a memory portion physically configured in accordance with computer program instructions that would cause the portable memory apparatus to provide a game outcome from the plurality of game outcomes to the gaming apparatus, and a memory portion physically configured in accordance with computer program instructions that would cause the portable memory apparatus to communicatively decouple from said gaming apparatus.

In yet another aspect, the invention is directed to a game purchasing apparatus which may include a display unit, a value input device and a controller operatively coupled to the display unit and the value input device. The controller may include a processor and a memory operatively coupled to the processor. The controller may be programmed to receive a value amount relating to a plurality of game plays, to generate a game outcome for each of the plurality of game plays, to associate the plurality of game outcomes with a player identification, to store the game outcomes on a portable memory apparatus as game outcome data, and to communicatively decouple from the portable memory apparatus.

In a still further aspect, the invention is directed to a method for providing a wagering game wherein a player may pre-purchase outcomes for the wagering game before playing the wagering game. The method may include providing a portable memory apparatus, providing a game outcome purchasing apparatus adapted to communicatively couple to the portable memory apparatus, storing game outcome data relating to one or more game outcomes on the portable memory apparatus in response to a request from a player to purchase at least one game outcome, dispensing the portable memory apparatus after the game outcome data has been stored thereon, providing a gaming apparatus adapted to communicatively couple to the portable memory apparatus, determining an outcome for a wagering game based on the game outcome data read by the gaming apparatus from the portable memory apparatus, determining whether the outcome comprises a winning outcome, and determining a value payout corresponding to a winning outcome if the outcome comprises a winning outcome.

Additional aspects of the invention are defined by the claims of this patent.

### BRIEF DESCRIPTION OF THE DRAWINGS

FIG. 1 is a block diagram of an embodiment of a gaming system in accordance with the invention;

FIG. 2 is a perspective view of an embodiment of one of the gaming units shown schematically in FIG. 1;

FIG. 2A illustrates an embodiment of a control panel for a gaming unit;

FIG. 3 is a block diagram of the electronic components of the gaming unit of FIG. 2;

FIG. 3A is a block diagram of the electronic components of the purchase unit shown schematically in FIG. 1;

FIG. 3B is a block diagram of the electronic components of the network computer shown schematically in FIG. 1;

FIG. 3C is a block diagram of the electronic components of the portable memory shown schematically in FIG. 1;

FIG. 4 is a representation of a data file that may be store on the portable memory;

FIG. 5 is a flowchart of an embodiment of a gaming routine that may be performed during operation of the gaming system;

FIG. 5A is a flowchart of an embodiment of a purchase routine that may be performed during operation of one or more of the purchase units;

FIG. 5B is a flowchart of an embodiment of a main routine that may be performed during operation of one or more of the gaming units;

FIG. 5C is a flowchart of an alternative embodiment of a main routine that may be performed during operation of one or more of the gaming units;

FIG. 5D is a flowchart of an embodiment of a verification routine that may be performed by one or more of the gaming units;

FIG. 5E is a flowchart of an embodiment of a reconciliation routine that may be performed during operation of one or more of the network computers;

FIG. 5F is a flowchart of an embodiment of a subscription routine that may be performed during operation of one or more of the network computers or during operation of one or more of the purchase units;

FIG. 5G is a flowchart of an embodiment of a remote main operating routine that may be performed during operation of a person electronic device

FIG. 6 is an illustration of an embodiment of a visual display that may be displayed during performance of the video poker routine of FIG. 8;

FIG. 7 is an illustration of an embodiment of a visual display that may be displayed during performance of the video blackjack routine of FIG. 9;

FIG. 8 is a flowchart of an embodiment of a video poker routine that may be performed by one or more of the gaming units;

FIG. 9 is a flowchart of an embodiment of a video blackjack routine that may be performed by one or more of the gaming units;

FIG. 10 is an illustration of an embodiment of a visual display that may be displayed during performance of the slots routine of FIG. 12;

FIG. 11 is an illustration of an embodiment of a visual display that may be displayed during performance of the video keno routine of FIG. 13;

FIG. 12 is a flowchart of an embodiment of a slots routine that may be performed by one or more of the gaming units;

FIG. 13 is a flowchart of an embodiment of a video keno routine that may be performed by one or more of the gaming units;

FIG. 14 is an illustration of an embodiment of a visual display that may be displayed during performance of the video bingo routine of FIG. 15; and

FIG. 15 is a flowchart of an embodiment of a video bingo routine that may be performed by one or more of the gaming units.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

A casino gaming system may centrally determinate game outcomes for a plurality of gaming units. For example, a network computer, or other centralized computer system, may be operatively coupled to one or more gaming units via a network. Each of the gaming units may include a random number generator to generate random numbers that correspond to outcomes of a game. The network computer may include one or more random number seed generator, which may correspond to the same random number sequence of the random number generator of a gaming unit. The seed generator may provide the seed values to a gaming unit. The gaming unit may use the seed value as a starting value for the random number sequence. Because the random number sequence and the starting value are known, the game outcome is already known, and the game outcome may be under the control of the network computer. This may be advantageous for accounting, auditing, and security purposes. An example of a gaming system with individualized, centrally-generated random number generator seeds is disclosed in U.S. Pat. No. 6,533,664, the contents of which are expressly incorporated by reference herein.

A desire exists for a player to be able to play one or more wagering games at various locations, on various computing devices and/or at various times, which may not always be conducive to a system that centrally-generates game outcomes. However, a casino gaming system which centrally generates game outcomes may store the game outcomes on a portable memory device which may be used by a player at the player's convenience, whether with different games, different wager amounts, at different locations or at different times, for example. In addition, the centrally-determined game outcomes allow the game outcomes to be known by the network computer. As such, a portable memory device is disclosed which may store a plurality of game outcomes, such as seed values, purchased by a player. The portable memory device may be used at the player's convenience in a variety of locations, with a variety of games and with a variety of wager denominations. However, limitations on use of the portable memory device may be imposed to limit a player's losses, and to allow the gaming system to know the outcomes and winnings for each wager.

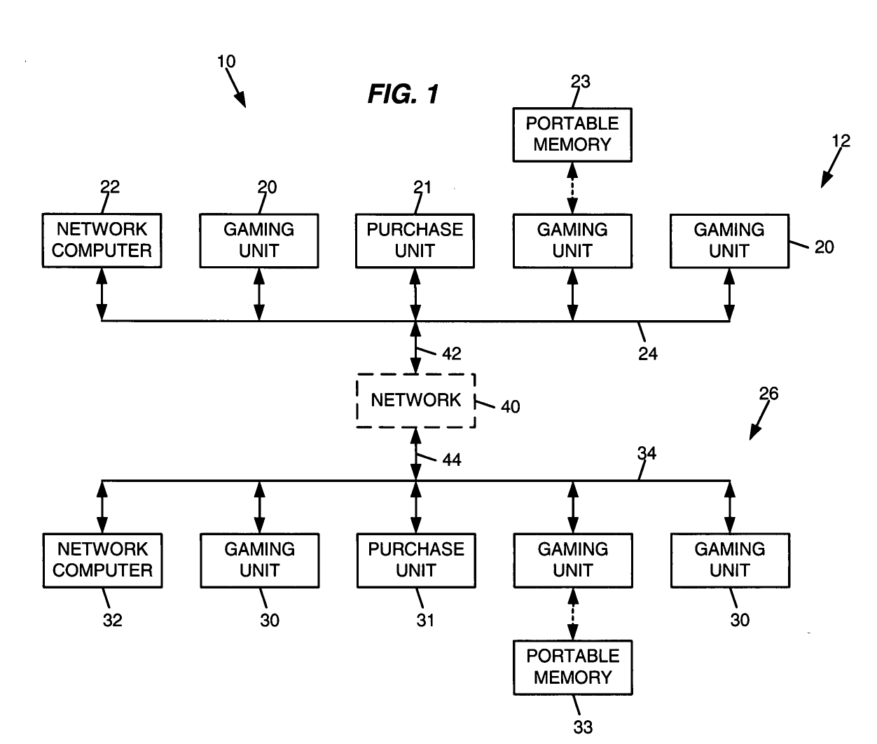

FIG. 1 illustrates one possible embodiment of a casino gaming system 10 in accordance with the invention. Referring to FIG. 1, the casino gaming system 10 may include a first group or network 12 of casino gaming units 20 operatively coupled to a purchase unit 21 and a network computer 22 via a network data link or bus 24. A portable memory 23 may be configured to be alternately communicatively coupled to and uncoupled from one or more of the gaming units 20. The casino gaming system 10 may include a second group or network 26 of casino gaming units 30 operatively coupled to a purchase unit 31 and a network computer 32 via a network data link or bus 34. A portable memory 33 similarly may be configured to be alternately communicatively coupled to and uncoupled from one or more of the gaming units 30. Although not shown, the portable memories 23, 33 may additionally be capable of being interchangeably and communicatively coupled with any of the gaming units 20, 30, the purchase units 21, 31 or the network computers 22, 32. The first and second gaming networks 12, 26 may be operatively coupled to each other via a network 40, which may comprise, for example, the Internet, a wide area network (WAN), or a local area network (LAN) via a first network link 42 and a second network link 44.

The first network 12 of gaming units 20 may be provided in a first casino, and the second network 26 of gaming units 30 may be provided in a second casino located in a separate geographic location than the first casino. For example, the two casinos may be located in different areas of the same city, or they may be located in different states. The network 40 may include a plurality of network computers or server computers (not shown), each of which may be operatively interconnected. Where the network 40 comprises the Internet, data communication may take place over the communication links 42, 44 via an Internet communication protocol.

The network computer 22 may be a server computer and may be used to accumulate and analyze data relating to the operation of the gaming units 20. For example, the network computer 22 may continuously receive data from each of the gaming units 20 indicative of the dollar amount (denomination) and number of wagers being made on each of the gaming units 20, data indicative of how much each of the gaming units 20 is paying out in winnings, paytables, game outcomes, game selections (e.g., hold/draw selections, hit/stay selections, payline selections, card selections, number selections, etc.), data regarding the identity and gaming habits of players playing each of the gaming units 20, data regarding the identity and location of the gaming unit 20, etc. The network computer 22 may also continuously receive data from the purchase unit 21, such as the identity of players purchasing games, game outcomes resulting from the purchase, time, date and location of purchase, pay tables, player financial accounts, etc., for reconciliation with data received from the gaming units 20 and the portable memory 23 (e.g., game outcomes, value payouts, denominations, etc.). In addition, the network computer 22 may receive data from the portable memory 23 such as time/date of gaming sessions or wagers, gaming unit identification, casino identification, game outcomes, denominations, etc. The network computer 32 may be a server computer and may be used to perform the same or different functions in relation to the gaming units 30, the purchase unit 31 and the portable memory 33 as the network computer 22 described above.

The purchase unit 21 may be a personal computer, a kiosk, cashier station or the like, or may be incorporated into a gaming unit 20. The purchase unit 21 may be used to purchase game outcomes, generate and/or store game outcomes on the portable memory 23, issue a portable memory 23 to a player and determine gaming limitations such as wager amounts, games, maximum allowed losses per day or per session, and the like. The purchase unit may also provide the above information to the network computer 22 for reconciliation with data from the gaming units 20 and the portable memory 23. The purchase unit 31 may be a personal computer, a kiosk, cashier station or the like, or may be incorporated into a gaming unit 30, and may be used to perform the same or different functions in relation to the network computer 32 and the portable memory 33.

The portable memory 23 may be a player tracking card with a magnetic strip, a smart card (e.g., a player tracking card with an embedded circuit), a flash memory, a recordable integrated circuit (IC), a personal digital assistant (PDA), a computer (e.g., a laptop computer), a cellular phone, a magnetic or optical memory such as a floppy disc or a compact disc, or any other memory device that may remain in the personal possession of a player, and may be removably and communicatively coupled by the player to the gaming units 20, 30, the purchase units 21, 31, etc. The portable memory 23 may be used to purchase and store game outcomes, as well as store game routines, gaming limitations, time/date of gaming sessions or wagers, player identification, gaming unit identification, gaming unit location, casino identification, transaction identification, denominations, player game play selections and inputs, gaming results generated by the gaming unit 20 (e.g., random numbers, associated outcomes, value payouts) and other gaming data relating to purchased game outcomes. Gaming data may relate to a variety of data regarding the gaming unit 20, the player, and gaming events associated with game play. Examples of gaming data, also referred to as session data or game play information, are further described in U.S. Patent Application Pub. No. 2004/0053675, which is hereby expressly incorporated by reference herein. Particular examples of gaming data are also described throughout further below. The portable memory 23 may provide the above information to the network computer 22 for reconciliation with data from the gaming units 20 and the purchase unit 21. While the portable memory 23 may be used to play games on some or all of the gaming units 20, 30, the portable memory 23 may also be used to play games on personal electronic devices such as a personal digital assistant (PDA), a personal computer (e.g., a laptop computer), a cellular phone, etc. The portable memory 33 may be a smart card, a flash memory, a recordable integrated circuit (IC), a personal digital assistant (PDA), a computer (e.g., a laptop computer), a cellular phone, etc., and may be used to perform the same or different functions in relation to the network computer 32, the purchase unit 31 and the gaming units 30.

Although each network 12, 26 is shown to include one network computer 22, 32, one purchase unit 21, 31, one portable memory 23, 33 and three gaming units 20, 30, it should be understood that different numbers of computers, purchase units, portable memories and gaming units may be utilized. For example, the network 12 may include a plurality of network computers 22 and purchase units 21, and tens or hundreds of gaming units 20, all of which may be interconnected via the data link 24. Likewise hundreds or thousands of portable memories 23 may be included, each being interchangeably utilized with the various gaming units 20, 30 and purchase units 21, 31. The data link 24 may be provided as a dedicated hardwired link or a wireless link. Although the data link 24 is shown as a single data link 24, the data link 24 may comprise multiple data links.

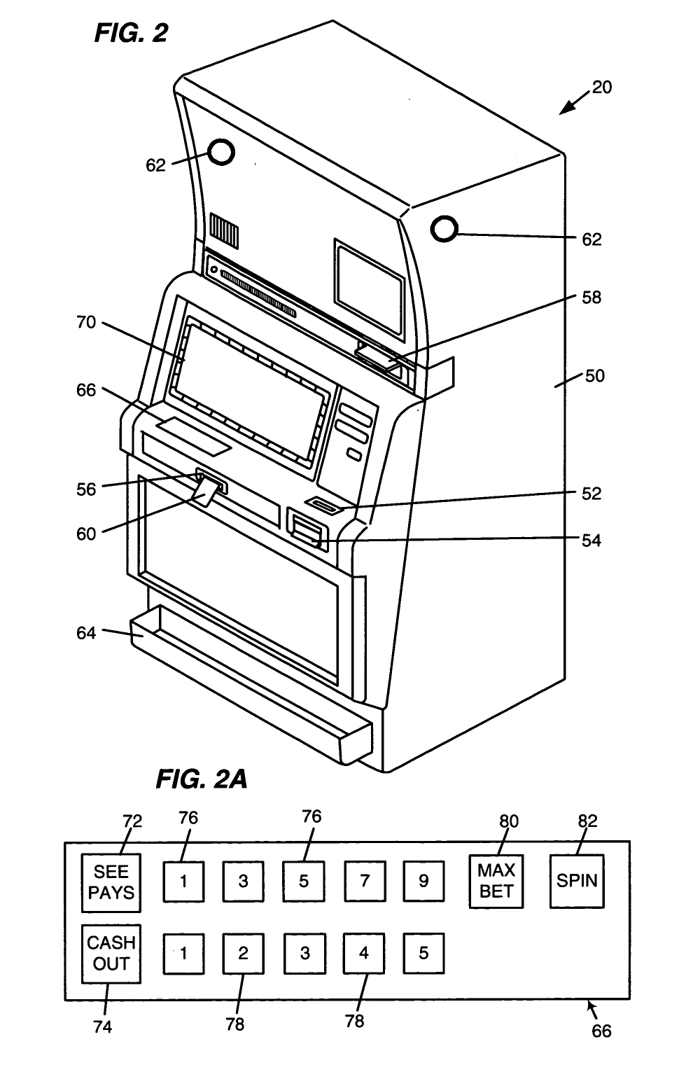

FIG. 2 is a perspective view of one possible embodiment of one or more of the gaming units 20. Although the following description addresses the design of the gaming units 20, it should be understood that the gaming units 30 may have the same design as the gaming units 20 described below. It should be understood that the design of one or more of the gaming units 20 may be different than the design of other gaming units 20, and that the design of one or more of the gaming units 30 may be different than the design of other gaming units 30. Each gaming unit 20 may be any type of casino gaming unit and may have various different structures and methods of operation. For exemplary purposes, various designs of the gaming units 20 are described below, but it should be understood that numerous other designs may be utilized.

Referring to FIG. 2, the casino gaming unit 20 may include a housing or cabinet 50 and one or more input devices, which may include a coin slot or acceptor 52, a paper currency acceptor 54, a ticket reader/printer 56 and a card reader 58, which may be used to input value to the gaming unit 20. A value input device may include any device that can accept value from a customer. As used herein, the term “value” may encompass gaming tokens, coins, paper currency, ticket vouchers, credit or debit cards, smart cards, and any other object representative of value.

If provided on the gaming unit 20, the ticket reader/printer 56 may be used to read and/or print or otherwise encode ticket vouchers 60. The ticket vouchers 60 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 60 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 60 could be printed with an optically readable material such as ink, or data on the ticket vouchers 60 could be magnetically encoded. The ticket reader/printer 56 may be provided with the ability to both read and print ticket vouchers 60, or it may be provided with the ability to only read or only print or encode ticket vouchers 60. In the latter case, for example, some of the gaming units 20 may have ticket printers 56 that may be used to print ticket vouchers 60, which could then be used by a player in other gaming units 20 that have ticket readers 56.

If provided, the card reader 58 may include any type of card reading device, such as a magnetic card reader or an optical card reader, and may be used to read data from a card offered by a player, such as a credit card, a player tracking card or the portable memory 23 (if provided as a smart card, a magnetic card, etc.). The card reader 58 may be used to read data from, and/or write data to, the portable memory 23 which may be capable of storing data representing the computer program instructions for the game routine, gaming limitations, time/date of gaming sessions or wagers, player identification, gaming unit identification, gaming unit location, casino identification, transaction identification, denominations, player game play selections and inputs, gaming results (e.g., random numbers, associated outcomes, value payouts), or other gaming data. The card reader 58 may also be used to read data from, and/or write data to, player tracking cards that are capable of storing data representing the identity of a player, the identity of a casino, the player's gaming habits, etc. In one example, the player tracking card and the portable memory 23 may be embodied in the same device. If provided as part of a purchase unit 21 incorporated in the gaming unit 20, the card reader 58 may be a portable memory reader/writer/dispenser and may be used to dispense a portable memory 23, such as a magnetic card or smart card, to a player and/or write game outcomes, such as seed values, to the portable memory 23 when a player purchases games.

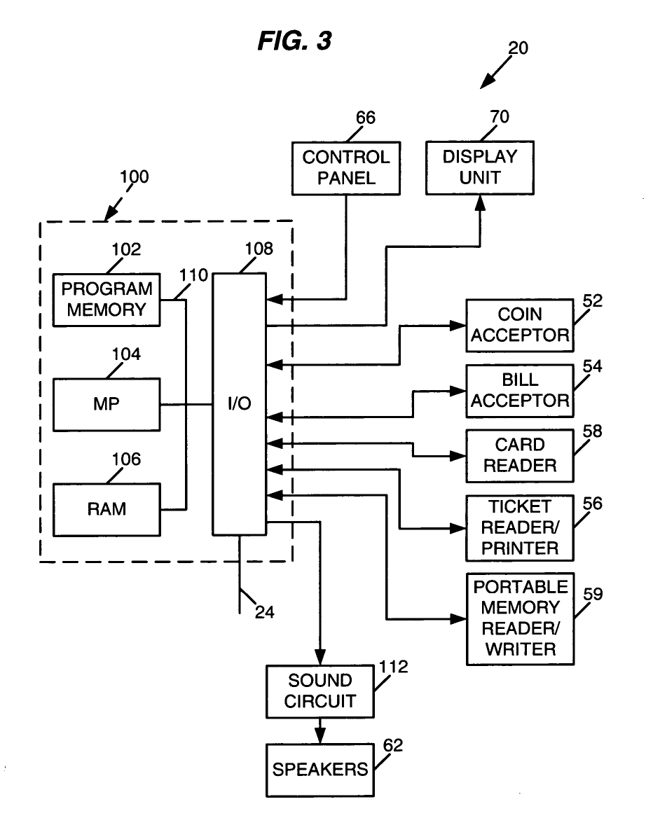

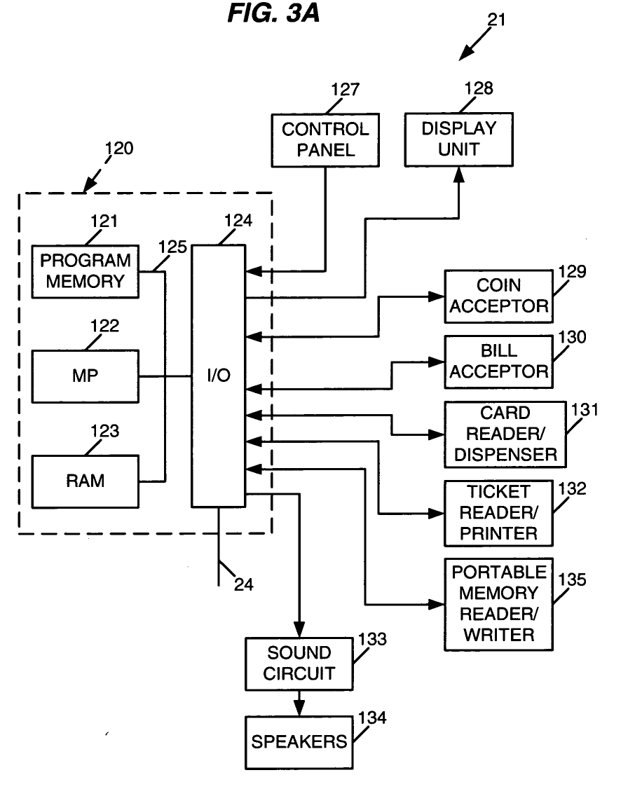

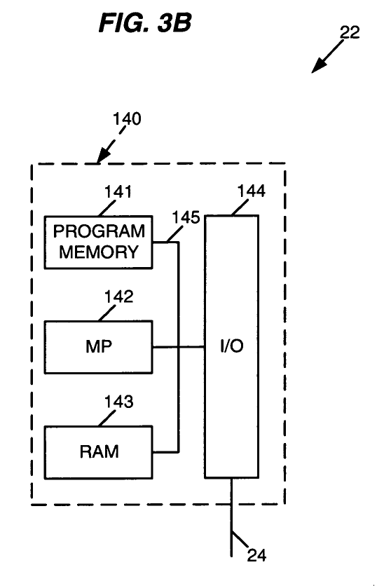

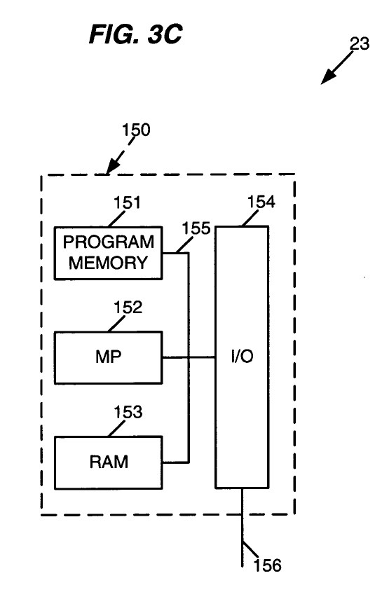

Although the card reader 58 may be provided as a card reader/writer capable of reading data from and writing data to a portable memory 23 such as a player tracking card and/or a smart card, the gaming unit 20 may also be provided with a portable memory reader/writer 59, as depicted below in FIG. 3. The portable memory reader/writer 59 may be capable of reading data from, and/or writing data to, the portable memory 23. The portable memory reader/writer 59 may include a wireless transceiver, a data port, a disk drive or any other device capable of communicatively coupling to a portable memory 23, including one or more of the various types of portable memories 23 disclosed above. If provided as part of a purchase unit 21 incorporated in the gaming unit 20, the portable memory reader/writer 59 may be a portable memory reader//writer/dispenser and may be used to dispense a portable memory 23 to a player and/or write game outcomes to the portable memory 23 when a player purchases games. In one example, the portable memory reader/writer 59 and the card reader 58 may be provided as the same device. further be provided as a portable memory reader/writer capable of reading data from and writing data to a portable memory 23 provided as something other than a player tracking card, examples of which have been disclosed above.

The gaming unit 20 may include one or more audio speakers 62, a coin payout tray 64, an input control panel 66, and a display unit 70. Where the gaming unit 20 is designed to facilitate play of a video casino game, such as video poker or video slots, the display unit 70 may be a color video display unit that displays images relating to the particular game or games. Where the gaming unit 20 is designed to facilitate play of a reel-type slot machine, the display unit 70 may comprise a plurality of mechanical reels that are rotatable, with each of the reels having a plurality of reel images disposed thereon. The audio speakers 62 may generate audio representing sounds such as the noise of spinning slot machine reels, a dealer's voice, music, announcements or any other audio related to a casino game. The input control panel 66 may be provided with a plurality of pushbuttons or touch-sensitive areas that may be pressed by a player to select games, make wagers, make gaming decisions, etc.

FIG. 2A illustrates one possible embodiment of the control panel 66, which may be used where the gaming unit 20 is a slot machine having a plurality of mechanical or “virtual” reels. Referring to FIG. 2A, if the display unit 70 is provided in the form of a video display unit, the control panel 66 may include a “See Pays” button 72 that, when activated, causes the display unit 70 to generate one or more display screens showing the odds or payout information for the game or games provided by the gaming unit 20. As used herein, the term “button” is intended to encompass any device that allows a player to make an input, such as an input device that must be depressed to make an input selection or a display area that a player may simply touch. The control panel 66 may include a “Cash Out” button 74 that may be activated when a player decides to terminate play on the gaming unit 20, in which case the gaming unit 20 may return value to the player, such as by returning a number of coins to the player via the payout tray 64.

If the gaming unit 20 provides a slots game having a plurality of reels and a plurality of paylines which define winning combinations of reel symbols, the control panel 66 may be provided with a plurality of selection buttons 76, each of which allows the player to select a different number of paylines prior to spinning the reels. For example, five buttons 76 may be provided, each of which may allow a player to select one, three, five, seven or nine paylines.

If the gaming unit 20 provides a slots game having a plurality of reels, the control panel 66 may be provided with a plurality of selection buttons 78 each of which allows a player to specify a wager amount for each payline selected. For example, if the smallest wager accepted by the gaming unit 20 is a quarter ($0.25), the gaming unit 20 may be provided with five selection buttons 78, each of which may allow a player to select one, two, three, four or five quarters to wager for each payline selected. In that case, if a player were to activate the “5” button 76 (meaning that five paylines were to be played on the next spin of the reels) and then activate the “3” button 78 (meaning that three coins per payline were to be wagered), the total wager would be $3.75 (assuming the minimum bet was $0.25).

The control panel 66 may include a “Max Bet” button 80 to allow a player to make the maximum wager allowable for a game. In the above example, where up to nine paylines were provided and up to five quarters could be wagered for each payline selected, the maximum wager would be 45 quarters, or $11.25. The control panel 66 may include a spin button 82 to allow the player to initiate spinning of the reels of a slots game after a wager has been made.

In FIG. 2A, a rectangle is shown around the buttons 72, 74, 76, 78, 80, 82. It should be understood that that rectangle simply designates, for ease of reference, an area in which the buttons 72, 74, 76, 78, 80, 82 may be located. Consequently, the term “control panel” should not be construed to imply that a panel or plate separate from the housing 50 of the gaming unit 20 is required, and the term “control panel” may encompass a plurality or grouping of player activatable buttons.

Although one possible control panel 66 is described above, it should be understood that different buttons could be utilized in the control panel 66, and that the particular buttons used may depend on the game or games that could be played on the gaming unit 20. If the display unit 70 is provided as a video display unit, the control panel 66 could be generated by the display unit 70. In that case, each of the buttons of the control panel 66 could be a colored area generated by the display unit 70, and some type of mechanism may be associated with the display unit 70 to detect when each of the buttons was touched, such as a touch-sensitive screen.

Gaming System Electronics

FIG. 3 is a block diagram of a number of components that may be incorporated in the gaming unit 20. Referring to FIG. 3, the gaming unit 20 may include a controller 100 that may comprise a program memory 102, a microcontroller or microprocessor (MP) 104, a random-access memory (RAM) 106 and an input/output (I/O) circuit 108, all of which may be interconnected via an address/data bus 110. It should be appreciated that although only one microprocessor 104 is shown, the controller 100 may include multiple microprocessors 104. Similarly, the memory of the controller 100 may include multiple RAMs 106 and multiple program memories 102. Although the I/O circuit 108 is shown as a single block, it should be appreciated that the I/O circuit 108 may include a number of different types of I/O circuits. The RAM(s) 104 and program memories 102 may be implemented as semiconductor memories, magnetically readable memories, and/or optically readable memories, for example.

Although the program memory 102 is shown in FIG. 3 as a read-only memory (ROM) 102, the program memory of the controller 100 may be a read/write or alterable memory, such as a hard disk, flash memory or ferroelectric random access memory (FE-RAM). In the event a hard disk is used as a program memory, the address/data bus 110 shown schematically in FIG. 3 may comprise multiple address/data buses, which may be of different types, and there may be an I/O circuit disposed between the address/data buses.

FIG. 3 illustrates that the control panel 66, the coin acceptor 52, the bill acceptor 54, the card reader 58, the ticket reader/printer 56 and the portable memory reader/writer 59 may be operatively coupled to the I/O circuit 108, each of those components being so coupled by either a unidirectional or bidirectional, single-line or multiple-line data link, which may depend on the design of the component that is used. The speaker(s) 62 may be operatively coupled to a sound circuit 112, that may comprise a voice- and sound-synthesis circuit or that may comprise a driver circuit. The sound-generating circuit 112 may be coupled to the I/O circuit 108.

As shown in FIG. 3, the components 52, 54, 56, 58, 59, 66, 112 may be connected to the I/O circuit 108 via a respective direct line or conductor. Different connection schemes could be used. For example, one or more of the components shown in FIG. 3 may be connected to the I/O circuit 108 via a common bus or other data link that is shared by a number of components. Furthermore, some of the components may be directly connected to the microprocessor 104 without passing through the I/O circuit 108.

FIG. 3A is a block diagram of a number of components that may be incorporated in the purchase unit 21. Referring to FIG. 3A, the purchase unit 21 may include a purchase controller 120 that may comprise of program memory 121, a microcontroller or microprocessor (MP) 122, a random access memory (RAM) 123, and an input/output (I/O) circuit 124, all of which may be interconnected via an address/data bus 125. It should be appreciated that although only one microprocessor 122 is shown, the purchase controller 120 may include multiple microprocessors 122. Similarly, the memory of the purchase controller 120 may include multiple RAMs 123 and multiple program memories 121. Although the I/O circuit 124 is shown as a single block, it should be appreciated that the I/O circuit 124 may include a number of different types of I/O circuits. The RAM(s) 123 and program memories 121 may be implemented as semiconductor memories, magnetically readable memories, and/or optically readable memories, for example.

Although the program memory 121 is shown in FIG. 3A as a read only memory (ROM) 121, the program memory of the purchase controller 120 may be a read/write or alterable memory, such as a hard disk, flash memory or FE-RAM. In the event a hard disk is used as a program memory, the address/data bus 125 shown schematically in FIG. 3A may comprise multiple address/data busses, which may be of different types, and there may an I/O circuit disposed between the address/data busses. The purchase unit 31 may likewise include a controller similar to the purchase controller 120 for the purchase unit 21.

FIG. 3A illustrates that a control panel 127, a coin acceptor 129, a bill acceptor 130, a card reader/dispenser 131, a ticket reader/printer 132 and a portable memory reader/writer 135 may be operatively coupled to the I/O circuit 124, each of those components being so coupled by either a unidirectional or bidirectional, single line or multiple line data link, which may depend on the design of the component that is used. A speaker(s) 134 may be operative coupled to a sound circuit 133, that may comprise a voice- and sound-synthesis circuit or that may comprise a driver circuit. The sound generating circuit 133 may be coupled to the I/O circuit 124. In addition, a control panel 127 and a display system 128 may be operatively coupled to the I/O circuit 124. If provided separately from a gaming unit 20, such as a kiosk, the components 129, 130, 132, 131, 134, 135, 127, 128, 133 of the purchase unit 21 may be similar to the components 52, 54, 56, 58, 59, 62, 66, 70, 112 described above. If the purchase unit 21 is incorporated into a gaming unit 20, each of the components 129, 130, 132, 131, 134, 135, 127, 128, 133 may respectively correspond to the components 52, 54, 56, 58, 59, 62, 66, 70, 112 discussed above, and the purchase controller 120 may correspond to the controller 100.

As shown in FIG. 3A, the components 127, 128, 129, 130, 131, 132, 133 may be connected to the I/O circuit 124 via a respective direct line or conductor. Different connection schemes could be used. For example, one or more of the components shown in FIG. 3A may be connected to the I/O circuit 124 via a common bus or other data link that is shared by a number of components. Furthermore, some of the components may be directly connected to the microprocessor 122 without passing thorough the I/O circuit 124.

FIG. 3B is a block diagram of a network controller that may be incorporated in the network computer 22. Referring to FIG. 3B, the network computer 22 may include a network controller 140 that may comprise a program memory 141, a microcontroller or a microprocessor (MP) 142, a random access memory (RAM) 143 and an input/output (I/O) circuit 144, all of which may be interconnected via an address/data bus 145. It should be appreciated that although only one microprocessor 142 is shown, the network controller 140 may include multiple microprocessors 142. Similarly, the memory of the network controller 140 may include multiple RAMs 143 and multiple program memories 141. Although the I/O circuit 144 is shown as a single block, it should be appreciated that the I/O circuit 144 may include a number of different types of I/O circuits. The RAM(s) 143 and program memories 141 may be implemented as semiconductor memories, magnetically readable memories, and/or optically readable memories, for example.

Although the program memory 141 is shown in FIG. 3B as a read only memory (ROM) 141, the program memory of the network controller 140 may be a read/write or alterable memory, such as a hard disk, flash memory or FE-RAM. In the event a hard disk is used as a program memory, the address/data bus 145 shown schematically in FIG. 3B may comprise multiple address/data busses, which may be of different types, and there may be an I/O circuit disposed between the address/data busses. A network computer 32 may likewise include a controller similar to the network controller 140 for the network computer 22.

FIG. 3C is a block diagram of a number of components that may be incorporated in the portable memory 23. Referring to FIG. 3C, the portable memory 23 may include a portable memory controller 150 that may comprise a program memory 151, a microcontroller or microprocessor (MP) 152, a random access memory (RAM) 153 and an input/output (I/O) circuit 154, all of which may be interconnected via an address/data bus 155. It should be appreciated that although only one microprocessor 152 is shown, the portable memory controller 150 may include multiple microprocessors 152. Similarly, the memory of the portable memory controller 150 may include multiple RAMs 153 and multiple program memories 151. Although the I/O circuit 154 is shown as a single block, it should be appreciated that the I/O circuit 154 may include a number of different types of I/O circuits. The RAM(s) 153 and program memories 152 may be implemented as semiconductor memories, magnetically readable memories and/or optically readable memories, for example.

Although the program memory 151 is shown in FIG. 3C as a read only memory (ROM) 151, the program memory of the portable memory controller 150 may be a read/write or alterable memory, such as a hard disk, flash memory or FE-RAM. In the event a hard disk is used as a program memory, the address/data bus 155 shown schematically in FIG. 3C may comprise multiple address/data busses, which may be of different types, and there may be an I/O circuit disposed between the address/data busses. The I/O circuit 154 may be removably coupled to a gaming unit 20, the purchase unit 21 or the network computer 22 via a data link 156, such as a wireless data link, a data port (e.g., a universal serial bus), a magnetically or optically readable link, for example. In one example, the portable memory controller 150 may comprise just a program memory 151 and/or a RAM 153 coupled directly to the data link 156. The portable memory 33 may likewise include a portable memory controller similar to the portable memory controller 150 for the portable memory 23.

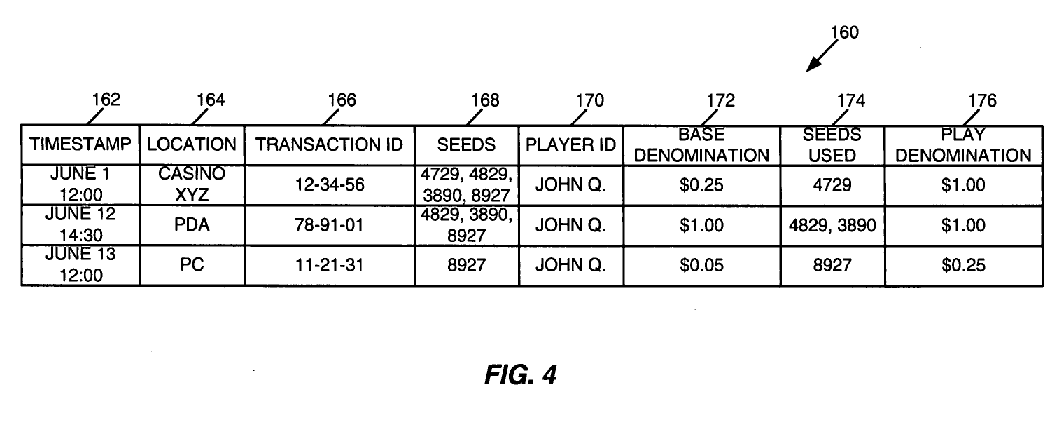

FIG. 4 is a representation of a data file that includes gaming data which may be stored in the portable memory 23. It should be understood that the portable memory 23 may contain data in addition to the data file shown in FIG. 4, including, but not limited to, game routines, gaming limitations, player game play selections and inputs, gaming results generated by the gaming unit 20 such as the randomly generated numbers, associated outcomes and associated value payouts, as well as additional gaming data described herein. Referring to FIG. 4, the data file 160 may arrange the gaming data according to gaming sessions. In another example, the data file 160 may be arranged according to game play. The data file 160 may include a time stamp 162 indicating a time and date of the game session and the duration of the game session. The data file 160 may further include the location 164 of the game session, which may include the name of the casino and/or an identification of the gaming units 20. A transaction identification 166 may be associated with each game session. The transaction identification 166 may also relate to a gaming unit identification, a game identification and associated wager denominations, random number generators and pay tables. Data relating to unused seed values may be stored as data relating to available seeds 168. A player identification 170 may be included to uniquely identify the purchaser of the seed values and/or the player of the gaming session. Data relating to the base denomination 172 for each game or gaming unit 20 may also be stored in the portable memory 23. The base denomination 172 may relate to a minimum wager amount which may vary depending on the game and/or gaming unit 20. The data file 160 may also include used game outcomes 174 (e.g., seed values) that were used for each game play or game session. Alternatively, the used game outcomes 174 may refer to the number of game outcomes used. Gaming data relating to the total amount wagered 176 may likewise be stored. The data file 160 may be updated accordingly during or following each game play, game session, game outcome, game outcome purchase, etc. As disclosed below, the data file 160 may be encrypted to protect the file contents from unauthorized access and modification.

Overall Operation of a Casino Gaming System

One manner in which one or more of the gaming units 20, the purchase unit 21, the network computer 22 and the portable memory 23 (and one or more of the gaming units 30, the purchase unit 31, the network computer 32 and the portable memory 33) may operate is described below in connection with a number of flow charts which represent a number of portions or routines of one or more computer programs, which may be stored in one or more of the memories of the controller 100, the purchase controller 120, the network controller 140 and the portable memory controller 150. In some instances, the computer program(s) or portions thereof may be stored remotely, outside of the gaming unit 20, the purchase unit 21, the network computer 22 or the portable memory 23, and may control operations from a remote location. Such remote control may be facilitated with the use of a wireless or hardwire connection, a dedicated connection or by an internet/intranet interface that connects the gaming unit 20, the purchase unit 21, the network computer 22 or the portable memory 23 with a remote computer having a memory in which the computer program portions are stored. The computer program portions may be written in any high level language such as C, C++, C#, Java or the like or any low level assembly or machine language. By storing the computer program portions therein, various portions of the memories 102, 106, 121, 123, 141, 143, 151, 153 are physically and/or structurally configured in accordance with computer program instructions.

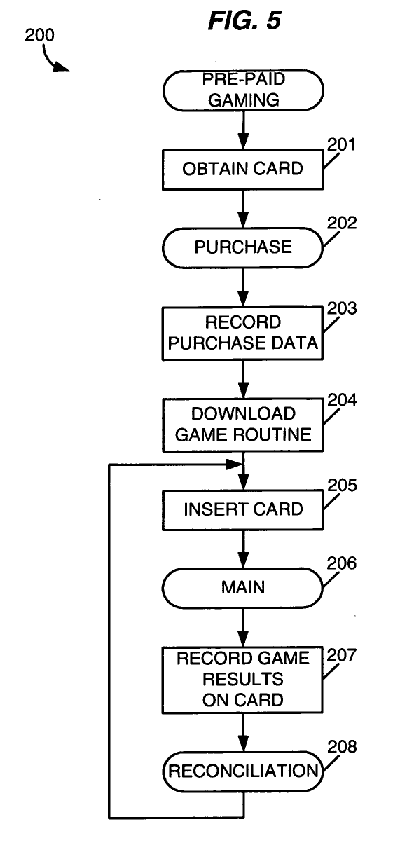

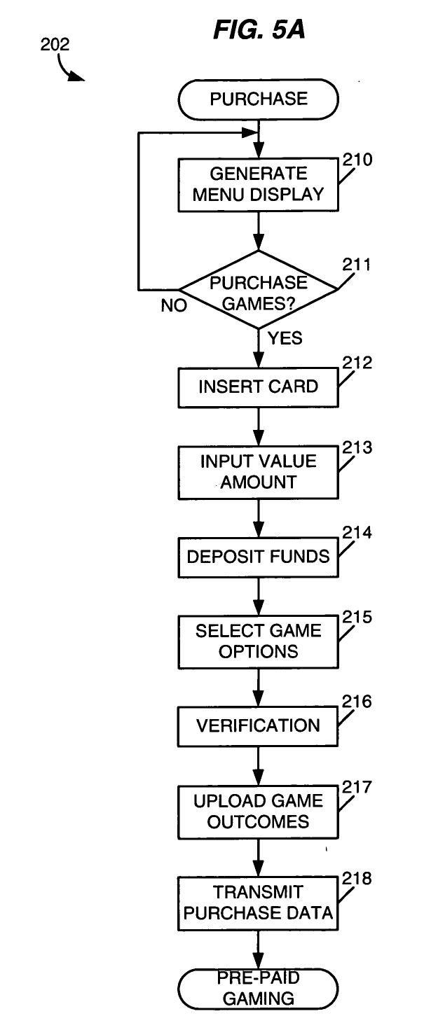

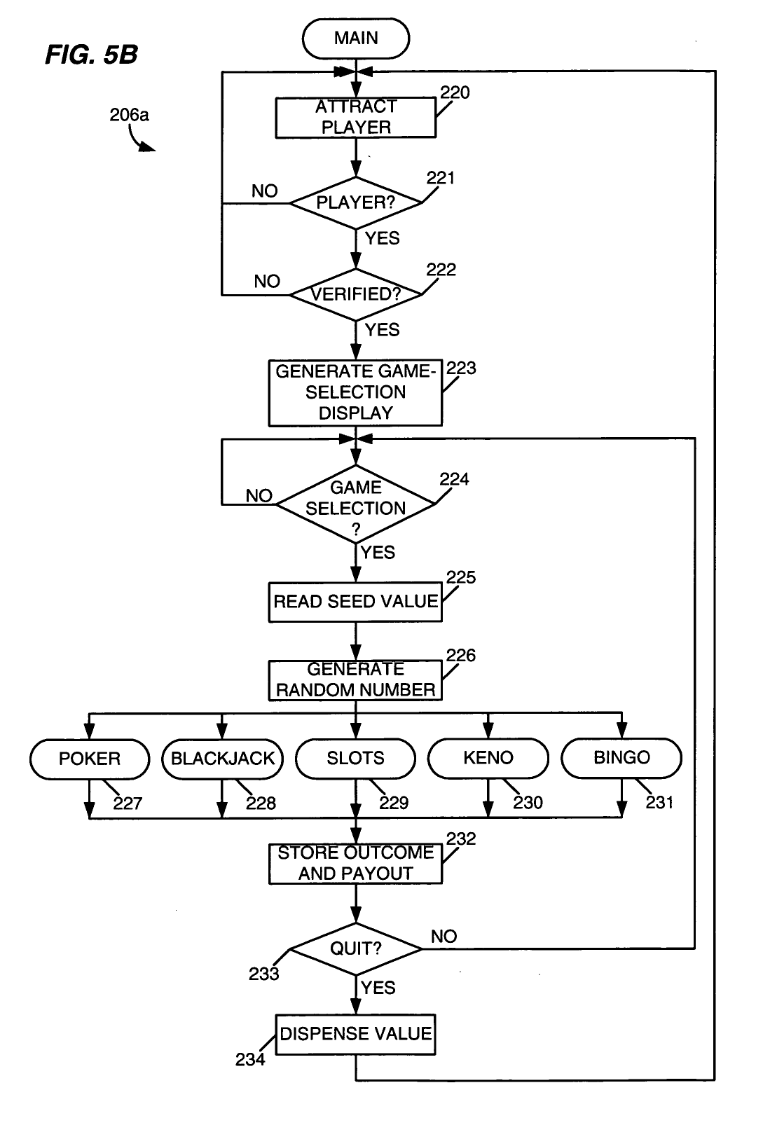

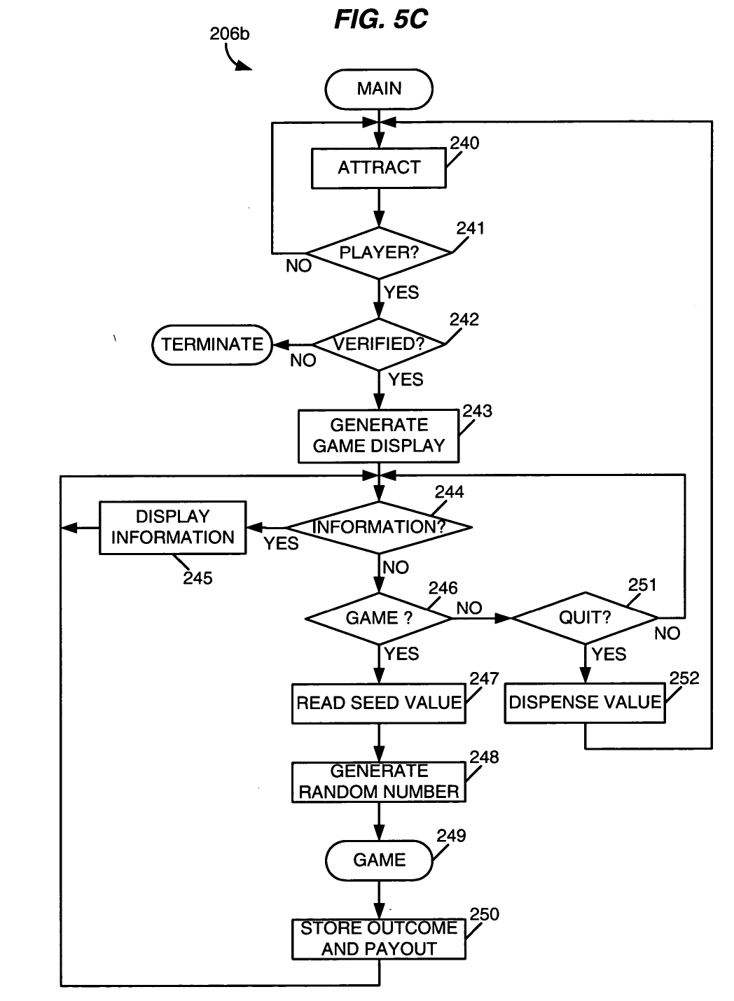

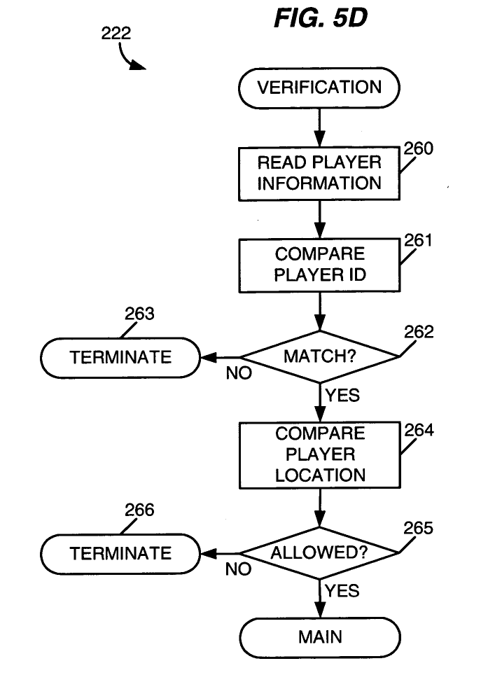

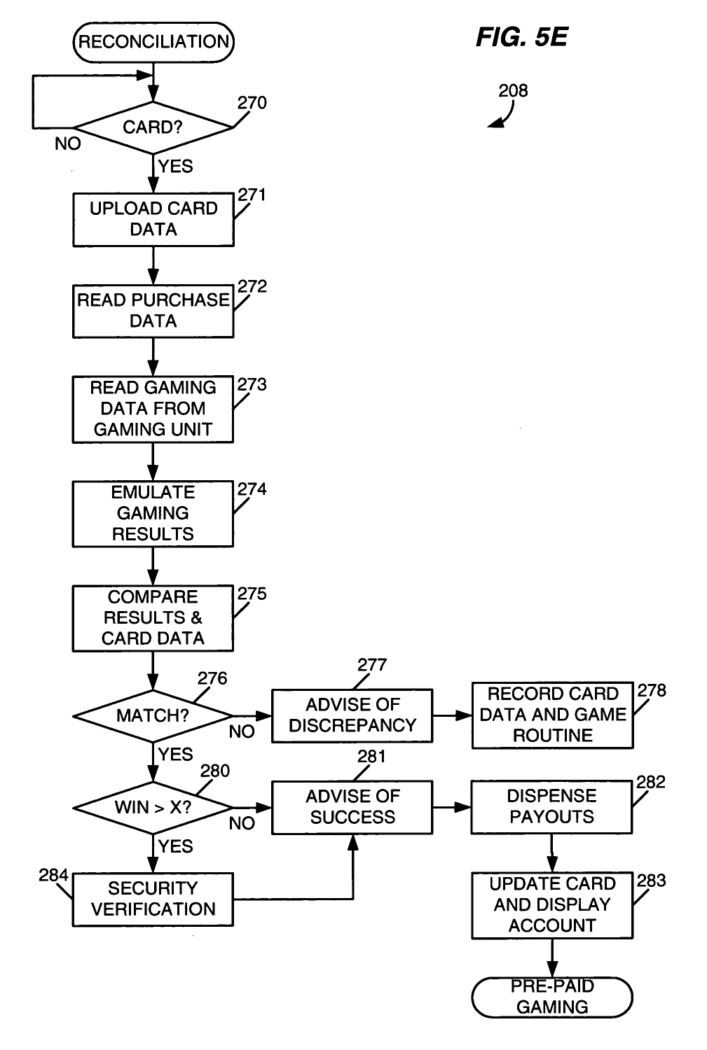

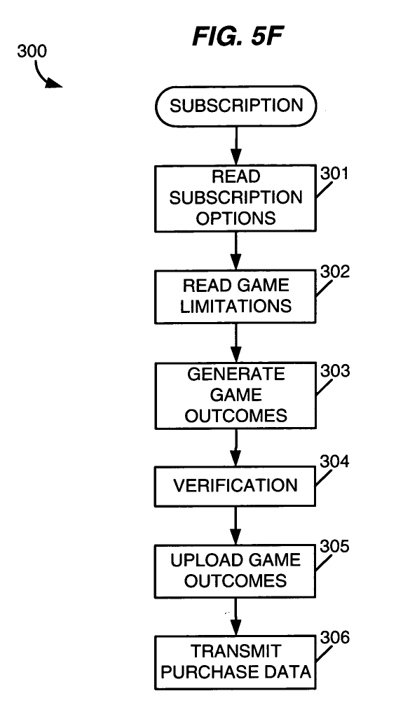

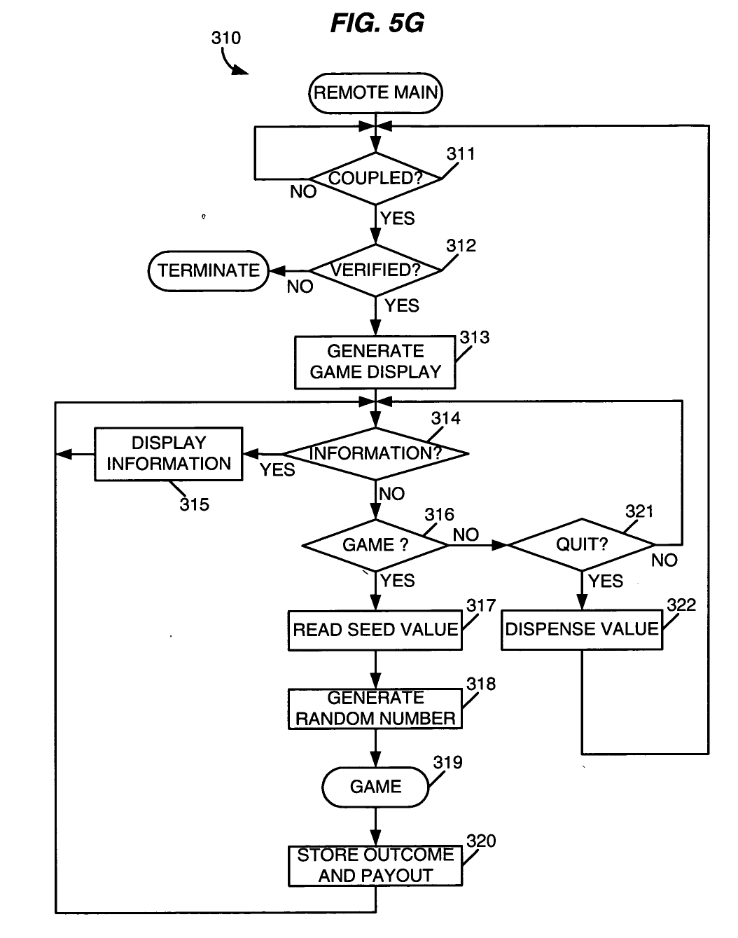

FIG. 5 is a flowchart of a prepaid gaming routine 200 that may be stored in the memory of the various controllers 100, 120, 140, 150. Referring to FIG. 5, the prepaid gaming routine 200 may begin operation at block 201 during which a player may obtain a portable memory 23, such as a smart card or other device as mentioned above. The portable memory 23 may be obtained at block 201 via a card reader/dispenser 56, 132. Alternatively, the portable memory 23 may be provided by a casino if a player registers for game play with the casino. In a further example, the portable memory 23 may be provided by the player, such as the player's cell phone, PDA or personal computer, wherein appropriate software as described herein may be stored in the portable memory 23. If the portable memory 23 has been previously provided, the player may communicatively couple the portable memory 23 to the purchase unit 21 at block 201 via a data link, such as by inserting the portable memory 23 into the card reader 132, establishing a wireless link or coupling the portable memory to a data port, for example. In yet another example, the portable memory 23 may be provided via delivery, such as delivering the portable memory 23 to the player's mailing address.

Having obtained a portable memory 23, a player may purchase a number of games according to a purchase routine 202, which may be performed by the purchase unit 21. During the purchase routine 202 the player may select the games to play (e.g., poker, blackjack, slots, bingo, keno), the number of game plays, player preferences (e.g., game theme) or wager denomination, for example. Also during the purchase routine 202, game outcomes may be generated and stored in the portable memory 23. The game outcomes may be stored as seed values used by random number generators or sequences as a starting value for generating a random number.

Purchase data generated by the purchase routine 202 may be recorded at block 203. The purchase data may be stored in a memory of the purchase unit 21 or in a memory of the network computer 23. As an example, the purchase data may include selections made by the player according to selected games, selected wager denominations and game themes. The purchase data may further include the time, date and location of purchase, pay tables for the selected games, player identification, the game outcomes, data regarding a player's financial accounts, etc. The purchase data may be used for player tracking purposes and for reconciling the purchase data with gaming results to detect tampering or manipulation of the game outcomes.

Block 204 may be utilized to encrypt and download data relating to one or more game routines to the portable memory 23. The game routine data may include computer program instructions which may be read from the portable memory 23 and executed by the gaming unit 20, a cellular phone, a PDA, a personal computer, etc. For example, the game routine data may include a random number generator, instructions for visual displays, etc. In another example, the game routine data may be downloaded directly to the gaming apparatus, such as the gaming unit 20, a PDA, a personal computer, a cell phone, etc. In yet another example, the game routine data may be preloaded on the gaming apparatus, rather than downloaded as at block 204. Thus, the prepaid gaming routine 200 may be executed without block 204.

When a player wishes to initiate a gaming session with a gaming apparatus, such as the gaming unit 20, the portable memory 23 may be communicatively coupled to the gaming unit 20 at block 205. The gaming unit 20 and the portable unit 23 may be communicatively coupled via a data link which may be a wireless interface, a data port, a card reader/dispenser 58, etc. For example, if the portable memory 23 is provided as a smart card, the smart card may be inserted into the card reader/dispenser 58. The gaming unit 20 may execute a main operating routine at block 206 which may verify the player's identity using a verification routine and execute a game routine if the player is authorized to use the portable memory 23. The game routine may be any one of the game routines disclosed herein, such as one of the five game routines 227, 228, 229, 230, 231 discussed further below, or another game routine. Gaming data from the game routine may be stored in the portable memory 23 at block 207, and may be stored as gaming data in the data file 160.

At block 208, the prepaid gaming routine 200 may perform a reconciliation routine to compare the purchase data stored by the purchase unit 21 (of the network computer 22), the gaming data stored by the gaming unit 20 (or the network computer 22) and the gaming data stored in the portable memory 23 to authenticate the game results, the value payouts and the game outcomes, and to search for discrepancies therein. The reconciliation routine 208 may be performed after each game play, each gaming session or whenever the player wishes to receive monetary funds from a value payout (e.g., electronic transfers to a personal account, cash payouts, etc.). Following the reconciliation routine 208, control may return to block 205 whereby the player may initiate another gaming session at a different time on the same gaming unit 20 or with another gaming unit either in the same casino or another casino serviced by the casino gaming system 10. A player may thereby purchase game outcomes and play different games, different gaming units 20, different gaming location, different times, etc. using the game outcomes purchased at block 202.

FIG. 5A is a flowchart of the purchase routine 202 shown schematically in FIG. 5 and which may be stored in the memory of the purchase controller 120 (or the controller 100). The purchase routine 202 may be executed at any time the player wishes to purchase game outcomes. In one example, the player may be prevented from purchasing game outcomes if existing game outcomes have not been used. Referring to FIG. 5A, the purchase routine 202 may begin operation at block 210 during which a menu display may be generated on the display unit 128 of the purchase unit 21 (or on the display unit 70 if purchasing game outcomes via a gaming unit 20) to allow the player to purchase games. The menu display generated at block 202 may further provide options to reconcile gaming data, review a personal financial account, withdraw value payouts, withdraw cash, deposit cash, change personal preferences, select a game, etc.

At block 211, the purchase routine 202 may determine whether or not the player has selected the option to purchase games. If not, the routine 202 may continue to generate the menu displayed at block 210. If the player has selected the option to purchase games, the player may be prompted to insert the portable memory 23 (if provided as a smart card, a magnetically readable card, an optically readable card, etc.) into the card reader/dispenser 131 (or the card reader/dispenser 58), or otherwise operatively couple the portable memory 23 to the purchase unit 21, via a data link such as via a wireless interface, a data port, etc. The purchase routine 202 may then prompt the player to input a value amount at block 213. The value amount may be used to determine the number of game outcomes to be stored in the portable memory 23. At block 214, the routine 202 may prompt the player to deposit funds for the input value amount determined at block 213. The funds may be deposited via electronic transfer from the player's account, via insertion of a credit card, debit card, a ticket, a ticket voucher, etc., or by depositing bills and/or coins into the purchase unit 21.

At block 215, the player may select game options, such as games, wager denominations and game themes, for example. The game options from block 215 may be stored in the portable memory 23. Also at block 215, the routine 202 may determine limitations on the use of the game outcomes to be stored in the portable memory 23, such as limits (if any) on wager denominations, games, gaming units 20 or gaming locations, for example. In one example, game outcomes purchased by the player may be provided without limitations on wager denominations, games, gaming locations, etc. The player may therefore use the purchased game outcomes for different games, different gaming units 20 and at different gaming locations and may further be permitted to vary the wager denomination for each game play. In another example, the player may be limited to wagering a particular denomination for each game play. Additional limitations on how the game outcomes may be utilized may include limiting the player to one or more particular games, particular gaming units or particular gaming locations, for example. It should be understood that various restrictions or restrictive ranges may likewise be applicable. For example, limitations may be applied to allow the player to use the portable memory 23 with any gaming unit 20 or game within a particular gaming location (e.g., casino). Limitations may also be applied to the total amount wagered within a period of time, thereby controlling wagering and potential losses. If limited to particular games, the pay tables and random number generators may be known at the time of purchase. If further limited to a particular denomination, the game outcomes and value payouts may be emulated and stored by the purchase unit 21 and/or the network computer 22.

Having selected the game options and/or establishing limitations, the player may input a personal identification at block 216 for identity and/or age verification, such as biometric data or an identification code, for example. The routine 202 may use the identification data to verify the player's age and identity, and may further store such data on the portable memory 23 for authentication and verification during game play as the player identification 170 in the data file 160.

At block 217, the purchase routine 202 may upload the game outcomes to the portable memory 223 and store the game outcomes as seed values 168 in the data file 160. As mentioned above, the game outcomes may include seed values which may be utilized as starting values for random number sequences to determine a random number. The resulting random number may relate to a particular outcome (e.g., win, loss), which, in turn, may relate to a particular value payout based on the wager denomination and the pay tables associated with the game. The game outcomes may be randomly generated by a central random number seed generator which may be stored in the purchase controller 120 or by the network controller 140. The game outcomes may have been previously generated and stored in a memory of the purchase controller 120 or the network controller 140, or the outcomes may be generated at block 217. The game outcomes may be randomly stored in the portable memory 23. The number of game outcomes to be uploaded on the portable memory 23 may be based on initial value amount from block 213, and the game limitations (if any) imposed at block 215. For instance, if the initial value amount was $10.00 and the minimum potential denomination is $0.01, then 1000 game outcomes (e.g., seed values) may be uploaded and stored in the portable memory 23 at block 217. On the other hand, if the initial value amount is $10.00 and the denomination for each wager is limited to $1.00, only ten game outcomes may be stored in the portable memory 23.

The game outcomes may also be stored in the portable memory 23 according to how the game outcomes will be used. For example, game outcomes relating to a first denomination may be stored as a first set of game outcomes, whereas game outcomes relating to a second denomination may be stored as a second set of game outcomes. The game outcomes may additionally be stored according to the game routines, the random number generators used by the game routines, casino, gaming units 20 or specific outcomes, for example. Thus, while game outcomes may include limitations on use, the portable memory 23 may store game outcomes having various limitations, thereby allowing the player to use the same portable memory with different games, denominations, gaming units 20, casinos, etc. despite limitations on how particular game outcomes may be used. In another example, the game outcomes may be universal or generic game outcomes which may be used with any game, denomination, location, etc.

In addition to uploading game outcomes to the portable memory 23 at block 217, the purchase routine 202 may further upload data relating to computer program instructions for the selected game routines to the portable memory 23. The game outcomes, limitations, player identity, game routines or any other data stored in the portable memory 23 may be encrypted and protected (e.g., write-protected) with a passcode known only to the casino, or other game outcome provider, to deter theft and manipulation of the data stored thereon. Asymmetric encryption may be utilized to allow one-way encryption. A hash function utilizing the data relating to the game outcomes may generate a signature unique to the game outcomes, whereby any alteration to the game outcomes may be detected by repeating the hash function and comparing the resulting signature to the unique signature generated during the purchase routine. The hash function may also generate the unique signature, or separate signatures, utilizing data relating to game limitations, player identity, game routines, or any other data stored in the portable memory 23 including the data file 160. The unique signature(s) may be stored in a memory of the network computer 22 and/or in a memory of the portable memory 23. In addition, the player may be provided with a passcode known to the player, to prevent unauthorized use of the game outcomes. Biometric data unique to the player may also be used for security purposes. After uploading the game outcomes, the portable memory 23 may be dispensed or otherwise operatively decoupled from the purchase unit 21.

At block 218, the purchase routine 202 may transmit the purchase data to the network computer 22 automatically or upon request. The purchase data may relate to the player's identity, the player's financial account, the game outcomes, the value amount, the selected game options, the game limitations and time and date of purchase, for example. The purchase data may be utilized by the network computer 22 to verify gaming results during the reconciliation routine 208.

Having been operatively decoupled from the purchase unit 21, the player may use the game outcomes on the portable memory to wager on one or more games at one or more gaming units 20. When the total amount wagered (on one or multiple game plays) is equivalent to the initial value amount used to purchase the game outcomes, the player may be prevented from further game play using the portable memory 23 regardless of the number of game outcomes that may remain stored in the portable memory 23. For example, if the player makes ten $1.00 wagers, ten game outcomes may be used and nine-hundred and ninety game outcomes may remain unused on the portable memory 23. However, the total amount wagered (i.e., $10.00) is equivalent to the initial value amount used to purchase the game outcomes (i.e., $10.00). On the other hand, if the player wagers $0.01 on each game play, all one-thousand game outcomes may be utilized.

FIG. 5B is a flowchart of a main operating routine 206a, shown schematically in FIG. 5 as block 206, that may be stored in the memory of the controller 100. Referring to FIG. 5B, the main routine 206a may begin operation at block 220 during which an attraction sequence may be performed in an attempt to induce a potential player in a casino to play the gaming unit 20. The attraction sequence may be performed by displaying one or more video images on the display unit 70 (if provided as a video display unit) and/or causing one or more sound segments, such as voice or music, to be generated via the speakers 62. The attraction sequence may include a scrolling list of games that may be played on the game unit 20 and/or video images of various games being played, such as video poker, video blackjack, video slots, video keno, video bingo, etc.

During performance of the attraction sequence, if a potential player makes any input to the gaming unit 20, as determined at block 221, the attraction sequence may be terminated and a verification routine may be initiated at block 222. The gaming unit 20 may detect an input at block 221 in various ways. For example, a gaming unit 20 could detect if the player presses any button on the gaming unit 20; the gaming unit 20 could determine if the player deposited one or more coins into the gaming unit 20; the gaming unit could determine if the player deposited paper currency into the gaming unit 20; the gaming unit 20 could determine if the player operatively coupled the portable memory 23 to the gaming unit 20; etc.

The verification routine at block 222 may be initiated to verify and authenticate the identity of the player and to determine whether the player is authorized to use the portable memory 23. The verification routine 222 may further verify that the portable memory 23, or the game outcomes stored thereon, are being used according to any limitations that have been imposed. For example, limitations on gaming units 20, games, denominations or location may be compared to the gaming unit 20 being used, available games, wager options, or the location of the gaming unit 20. An example of the verification routine 222 is disclosed further below. If the player identity, and any use limitations, are verified by the verification routine 222, the main operating routine 206a may continue. Otherwise, the portable memory 23 may be decoupled from the gaming unit 20, or the player may be prompted to decouple the portable memory 23, and control may return to block 220.

If the player's identity and use limitations are verified at block 222, a game selection display may be generated on the display unit 70 (if provided as a video display unit) at block 223 to allow the player to select a game available on the game unit 20. The game selection display generated at block 223 may include, for example, a list of video games that may be played on the gaming unit 20 and/or visual message to prompt the player to deposit value into the gaming unit 20. The game selection display may further include any game routines stored in the portable memory 23, if provided. While the game selection display is generated, the display unit 20 may wait for the player to make a game selection.

On selection of one of the games by the player as determined at block 224, the controller 100 may cause a seed value, or other form of game outcome, to be decrypted and read from the portable memory 23 at block 225. In reading a seed value at block 225, the main routine 206a may read only those seed values that have not been used in a previous gaming session, such as the unused seed values 168 in the data file 160. The seed value may be selected randomly from a plurality of unused seed values stored in the portable memory 23. Alternatively, the seed values may be selected sequentially, which may be the case if the game outcomes were stored randomly on the portable memory 23. The seed value may also be selected according to how the seed value is used. For example, the game outcome may be selected from a group of game outcomes for a particular game, a particular gaming unit 20, a particular casino or a particular wager denomination, for example. Although a seed value may be read and decrypted upon a game selection at block 223, in another example the seed value may be read upon execution of one of the game routines described further below. Further, multiple seed values may be read at block 225 for multiple game plays of the selected game routine or for multiple game plays among multiple game routines.

As mentioned above, the number of seed values stored in the portable memory 23 may relate to the maximum number of possible wagers based on a minimum possible wager denomination. If a wager for a gaming routine is larger than the minimum denomination, a seed value may be selected at block 225 and an additional amount of seed values, commensurate with the amount wagered, may be marked as used, such that when the total amount wagered is equivalent to the initial value amount, no seed values remain available. Alternatively, unused seed values may remain unused and a record may be retained on the portable memory 23 to indicate when the total amount wagered is equivalent to the initial value amount used to purchase the game outcomes. Any remaining seed values may be used if the player provides an additional value amount entitling the player to further game outcomes. The seed value read at block 225, or a copy thereof, may be downloaded to the memory of the controller 100.

A random number generator may be stored in a memory of the controller 100 or downloaded from the portable memory 23 as part of a game routine. Generally, the random number generator may correspond to the random number seed generator used to generate the game outcomes, which may allow the gaming results to be known at the time of purchase. In other words, the random number sequence used by the random number generators of the gaming units 20 may be the same as the random number sequence used by the random number seed generator. Using the seed value read at block 225, a random number may be generated from the random number generator at block 226. The seed value read from block 225 may be used as a starting value for a random number sequence initiated by the random number generator. The random number may be associated with an outcome and a value payout based on the outcome. Upon generating the random number at block 226, the controller 100 may cause one of a number of game routines to be performed to allow the selected game to be displayed and played. Alternatively, the random number may be generated as part of the gaming routine 227, 228, 229, 230, 231, as described further below. The game routines could include a video poker routine 227, a video blackjack routine 228, a slots routine 229, a video keno routine 230, and a video bingo routine 231.

After one or more of the routines 227, 228, 229, 230, 231 have been performed to allow the player to play one or more game plays, block 232 may be utilized to store the random number generated from the seed value, or the outcome associated with the random number, of the selected game routine. Also at block 232, any value payouts determined from one of the game routines 227, 228, 229, 230, 231 may be stored. The main routine 206a may store the gaming results (i.e., the random number or the outcomes associated therewith, and/or value payouts generated from the gaming routine(s)) on a memory of the controller 100 and/or a memory of the portable memory 23. The gaming results may be stored following each game play. The main routine 206a may further store additional gaming data generated during one or more of the game routines 227, 228, 229, 230, 231, such as a time and date, location data, a player identification, gaming unit 20 identification and location, casino identification, a transaction identification, a base denomination for the game, the total amount wagered, the number of wagers, used and unused seed values, pay tables and player game play selections and inputs (e.g., selected pay lines, draw/hold selections, hit/stay selections, number of selections, card selections, etc.), for example. Some or all of the gaming data may be used to update the data file 160 on the portable memory 23, including, but not limited to, the timestamp 162, the location 164, the transaction identification 166, the unused game outcomes 168, the used game outcomes 174, the base denomination 172 and the play denomination 176. Although gaming data may be stored following each game play, the gaming data may be stored following a gaming session involving multiple game plays for one or more of the game routines 227, 228, 229, 230, 231. In addition, the gaming data may be transmitted by the controller 100 to the network computer 22 for the reconciliation routine 208.

Block 233 may be utilized to determine whether the player wishes to terminate play on a gaming unit 20 or to select another game. If the player wishes to stop playing the game 20, which wish may be expressed, for example, by selecting a “cash out” button, the controller 100 may dispense value to the player or to the portable memory 23 at block 234 based on the outcome of the game(s) played by the player. The operation may then return to block 220. In addition, computer program instructions relating to the game(s) may be uploaded to the portable memory 23 to allow the player to play the same game(s) at another time on the same gaming unit 20 or another gaming unit. In one example, the computer program instructions may be provided if the gaming unit 20 downloaded the computer program instructions from the portable memory 23 or if the gaming unit 20 was the purchasing unit 21 of the game outcomes purchased by the player. The computer program instructions may include the random number generator for the game(s), pay table for the game(s), graphics for the game(s), etc. If the player did not wish to quit as determined at block 233, the routine may return to block 224 where the game selection display may again be generated to allow the player to select another game.

It should be note although five game routines are shown in FIG. 5B, a different number of routines could be included to allow play of a different number of games. The gaming unit 20 may also be programmed to allow play of different games. In addition, more than one seed value could be read at block 225, and more than one random number may be generated at block 226 to allow multiple game plays during the selected game routine 227, 228, 229, 230, 231. In another example, each of the game routines 227, 228, 229, 230, 231 may relate to a single game play wherein a new seed value is read from the portable memory 23, and a new random number generated, for each subsequent game play. Although the value dispensed at block 234 may relate to an electronic transfer of funds, a personal account, dispensation of cash, coins, tokens or vouchers, a value may also be dispensed by storing data relating to the dispensed value on the portable memory 23. Funds may then be dispensed to the player following the reconciliation routine 208 described further below.

FIG. 5C is a flowchart of an alternative main operating routine 206b shown schematically in FIG. 5, that may be stored in the memory of the controller 100. The main routine 206b may be utilized for gaming units 20 that are designed to allow play of only a single game or a single type of game, or if the purchase limitations restrict play to a particular game or type of game. Referring to FIG. 5C, the main routine 206b may begin operation at block 240 during which an attraction sequence may be performed in an attempt to induce a potential player in a casino to play the gaming unit 20. An attraction sequence may be performed by displaying one or more video images on the display unit 70 (if provided as a video display unit) and/or causing one or more sound segments, such as voice or music, to be generated via the speaker 62.

During performance of the attraction sequence, if a potential player makes any input to the gaming unit 20 as determined at block 241, the attraction sequence may be terminated and a verification routine 242 performed to verify and authenticate the player's identity and limitations on use of the game outcomes. The verification routine 242 may be the verification routine 222 disclosed herein. Once a player's identity has been verified and authenticated, a game display may be generated on the display unit 70 (if provided as a video display unit) at block 243. The game display generated at block 243 may include, for example, an image of the casino game that may be played on the gaming unit 20 and/or a visual message to prompt the player to deposit value into the gaming unit 20. At block 244, the gaming unit 20 may determine if the player requested information concerning the game, in which case the requested information may be display at block 245. Block 246 may be used to determine if the player requested initiation of the game, in which case at block 247 a seed value may be decrypted and read from the portable memory 23. The controller 100 may generate a random number using the seed value at block 248. The game routine 249 may then be performed by associating the random number with an outcome and any resulting value payout. The game routine 249 could be any of the game routines disclosed herein, such as one of the five game routines 227, 228, 229, 230, 231, or another game routine. The game routine 249 may relate to single game play, or the game routine 249 may relate to multiple game plays in which case multiple seed values may be read at block 247 and multiple random numbers may be generated at block 248 for each game play.

After the game routine 249 has been performed to allow the player to play the game, block 250 may be utilized to store the gaming results (i.e., outcomes and/or value payouts) generated during the game routine 249 on a memory of the controller 100 and/or in memory of the portable memory 23. Additional gaming data, such as the gaming data as described above may also be stored at block 250. The gaming data may be stored in the portable memory 23 by updating the data file 160.

After the gaming results, and any additional gaming data, have been stored at block 250, control may return to block 244 to display further information or to play another game. Block 251 may be utilized to determine whether the player wishes to terminate play on the gaming unit 20. If the player wishes to stop playing the gaming unit 20 which wish may be expressed, for example, by selecting a “cash out” button, the controller 100 may dispense value to the player at block 252 based on the gaming results of the gaming routines played by the player. The operation may then return to block 240. If player did not wish to quit as determined at block 251, the operation may return to block 244.

Although the above game routines 227, 228, 229, 230, 231 have been described as allowing a player flexibility regarding gaming selections, such as a wager denomination (e.g., a bet amount) it should be understood that limitations imposed during the purchase routine 202 may result in the game selections not being made available to the player. For example, if the player is limited to a particular game, a game routine that does not correspond to the game limitation may not be executed by the main routine 206a, 206b. As another example, a limitation regarding a wager denomination may be read from the portable memory 23 and taken into account when the player inputs a bet amount during one of the game routines 227, 228, 229, 230, 231, which may result in notifying the player of an invalid bet amount or automatically placing the correct bet amount on behalf of the player.

FIG. 5D is a flowchart of the verification routine 222 shown schematically in FIG. 5B and which may be stored in the memory of the controller 100. Referring to FIG. 5D, the verification routine 222 may begin operation at block 260 where the verification routine 222 may read player identification information from the portable memory 23. As mentioned above, the player identification information may include biometric data (e.g., fingerprint characteristics, voiceprint characteristics, facial recognition, etc.), a verification code or location data as determined by a global position system (GPS), for example.

The verification routine 222 may compare the player identification data to previously stored identification data at block 261. The previously stored identification data may relate to the verification data recorded at block 216 of the purchase routine 202 or other previously stored identification data, which may be retrieved by the verification routine 222 from the network computer 22. Characteristics read from the player identification read at block 260 may be compared to previously stored characteristics associated with the player's identity. For example, fingerprint characteristics may be compared to a stored fingerprint. Likewise, voice characteristics which may be determined from the voice pattern read at block 260 may be compared to characteristics of a previously recorded voice pattern associated with the player's identity. Location data read at block 260 may be compared to previous location data.

At block 262, the verification routine 222 may determine whether the identification data read at block 260 matches the previously stored identification data based on the comparison at block 261. The determination of whether a match exists or not at block 262 may be based on an exact match or a degree of match. For example, an identification code provided by the player and read at block 260 may be required to exactly match that of a previously stored identification code. On the other hand, only a minimum number of characteristics of a fingerprint or voiceprint may be required to match against stored characteristics.

If the identification code, fingerprint data and/or voiceprint data are not considered a match with previously stored identification data, as determined at block 262, the verification routine 222 may terminate the game session at block 263. Otherwise, the verification routine 222 may proceed to block 264, where the verification routine 222 may compare the player's current location with the player's last known location which may be provided by the network computer 22. The location data may be provided to determine whether the player is allowed to use the portable memory 23 at a particular gaming location based on the gaming limitations provided during the purchase routine 202. If the player is within an allowed location (e.g., a particular casino) as determined at block 265, the player may be permitted to continue with the gaming session on the gaming unit 20. If the player is within an unauthorized gaming location, the verification routine 222 may terminate the gaming session at block 266.

FIG. 5E is a flowchart of a reconciliation routine 208 shown schematically in FIG. 5, and which may be stored in the memory of the network controller 140. Referring to FIG. 5E, the reconciliation routine 208 may begin operation at block 270 during which the presence of the portable memory 23 may be determined. The presence of the portable memory may be determined based on the player communicatively coupling the portable memory to a device such as a gaming unit 20, a purchase unit 21 or another interface, such as a personal computer, PDA, cell phone, etc., and initiating the reconciliation routine 208. Alternatively, the reconciliation routine 208 may be automatically initiated any time the portable memory 23 is communicatively coupled to the network 12.

If the portable memory 23 has been communicatively coupled to the network controller 140 as determined at block 270, the network controller 140 may upload gaming data stored in the portable memory 23 in the data file 160 at block 271, including, but not limited to, the seed values, the used seed values, the gaming results generated by a gaming unit 20, the wager/session times and dates, the gaming unit 20 identification and location, the casino identification, the minimum denomination of wagers, and denominations of total wagers, for example. In addition, each of the above-identified gaming data may be associated with a transaction identification 166. The transaction identification may relate to a particular game play or a gaming session involving one or more game plays.

The network controller 140 may further read purchase data at block 272, which may be stored in a memory of the network controller 140 or a memory of the purchase controller 120. Among the purchase data read by the network controller 140 may be data regarding the game outcomes purchased during the purchase routine 202, which may include the seed values originally generated and stored in the portable memory 23 by the purchase controller 120.

In addition, the network controller 140 may read gaming data from the gaming unit 20 and/or any additional gaming apparatuses that utilized game outcomes stored in the portable memory 23 at block 273. The gaming data from the gaming unit 20 may include game play or game session time and date, identification data, location data, casino identification, a transaction identification, a player identification, a base denomination for the game, the total amount wagered, the number of wagers, used and unused seed values, pay tables and gaming selections, value payouts, the random numbers generated or the outcomes associated with the random numbers, for example. In one example, the gaming data from the gaming unit 20 may be of the same type as the gaming data for the portable memory 23 including the gaming data stored in the data file 160. The gaming data from the gaming unit 20 may be previously stored in a memory of the network controller 140 and read at block 273, or read directly from the gaming unit 20 at block 273.

In order to verify the results stored in the portable memory 23, the network controller 140 may emulate the gaming results based on gaming data read from the gaming unit 20 and purchase data read from the purchase unit 21 at block 274. If the original game outcomes purchased from the purchase unit 21 included limitations regarding wager denominations, value payouts and games, the emulated results determined at block 274 may be determined without the gaming data read from the gaming unit 20 at block 273. For example, because the seed values are known at the time of purchase and the player is limited to a particular game, and hence a particular random number generator and pay table, the outcomes of each game play may be emulated at the time of purchase. In addition, because the player is limited to a particular pay table, and further limited to a particular wager denomination, the value payout for each game may also be emulated at the time of purchase. In effect, the emulation of gaming results at block 274 may include reading gaming results emulated at the time of purchase and stored in a memory of the purchase controller 120 or the network controller 140.

If the player is permitted flexibility in game play (e.g., flexibility in wager denomination, games, gaming units 20 or gaming locations), the network controller 140 may emulate the gaming results by effectively replaying each game play based on the gaming data read from the gaming units 20 at block 273. For example, the gaming data from the gaming units 20 may include game selections, wager denominations, games played and used seed values, all of which may be used as input data to the network computer 22. The network computer 22 may also be provided with access to or copies of, the game routines and random number generators used for each game play. In emulating the gaming results, the seed value used for a particular game play may be used with the random number generator, and the network controller 140 may determine the random number generated for that particular game play. Alternatively, the original seed values, as provided by the purchase unit 21, may be used to determine the random number. The network controller 140 may then use the random number to determine the outcome of the game play, and further use the payout tables to determine the associated value payout. The network controller 140 may thereby emulate the gaming results for each game play.

Using the emulated gaming results determined at block 274, the network controller 140 may compare the emulated gaming results with the gaming results stored in the portable memory 23 at block 275. In one example, the gaming results read from the portable memory 23 may also be emulated from the gaming data stored in the portable memory 23. In addition, the network controller 140 may compare any additional gaming data stored in the portable memory 23 with comparable gaming data read from the gaming units 20. If there is a discrepancy between the emulated gaming results and the gaming results stored in the portable memory 23, and/or the gaming data read from the portable memory 23 and the gaming unit 20, as determined at block 276, network controller 140 may advise the player and/or the casino of the discrepancy at block 277. At block 278, the network controller 140 may record the data causing the discrepancy, a copy of the gaming routine and/or random number generator, the gaming data associated with the gaming session where the discrepancy took place, etc., for further analysis to determine if the player had tampered with the portable memory 23 or the gaming unit 20.

If the emulated gaming results and the gaming results from the portable memory 23, and the gaming data from the portable memory 23 and the gaming unit 20, are consistent, as determined at block 276, the routine 208 may determine at block 280 whether or not the total amount won by the player is greater than a predetermined amount. If so, block 284 may be utilized for additional security verification. In addition, block 284 may be utilized by the casino to fill out any applicable government tax forms and/or pay any applicable government taxes, provided the total amount won by the player triggers such requirements. If the total amount won by the player is not over a particular threshold value, as determined at block 280, or after the security verification at block 284, the player may be advised of the successful reconciliation. The payouts may then be dispensed to the player at block 282 by electronic funds transfer, a cash or coin payout, presentation of a voucher, etc., or may be dispensed at any time following reconciliation. At block 283, the gaming data on the portable memory 23 may be updated to indicate the successful reconciliation and the dispensation of the payouts from block 282. If provided with a video display unit, the network controller may display a summary of the player's gaming results, including a player's account.

Overall Operation of a Remote Gaming System

While the above description has disclosed a casino gaming system that may utilize game outcomes stored in a portable memory 23 with a casino gaming unit, the game outcomes and the portable memory 23 may also be utilized with gaming units 20 provided as personal electronic devices such as a cellular phone, a personal digital assistant or a computer, for example. The personal electronic devices may thereby allow a player to utilized the game outcomes and the portable memory 23 in a variety of locations, including the player's home. It should be understood that many of the examples disclosed above are applicable to or modifiable for use with a personal electronic device. For example, a player may communicatively couple the portable memory 23 to a home computer, or other personal electronic device, which may establish a remote communication with the network computer 22 and/or the purchase unit 21 via the Internet using a secure communication channel. The purchase routine 202 described with respect to FIG. 5A may be performed using the interface of the personal electronic device of the player in conjunction with the network computer 22 and or the purchase unit 21. The resulting game outcomes may be transferred from the network computer 22 or the purchase unit 21 to the portable memory 23 via the connection with the personal electronic device of the player.

In another example, the game outcomes may be purchased through a subscription, whereby a player may receive additional game outcomes on a recurring basis, such as weekly, monthly, bimonthly, etc. The game outcomes may be generated by the network computer 22 or the purchase unit 21 based on the player's subscription options, such as games, number of game plays, player preferences or wager denomination. The network computer 22 or purchase unit 21 may further impose game limitations. The game outcomes may be provided on a memory device which may be a new portable memory 23 delivered to a player's mailing address. In such a case, the portable memory 23 may be a disposable, read-only memory such as a compact disc read-only memory (CD-ROM). Alternatively, the game outcomes may be delivered or otherwise provided on a temporary, disposable memory and transferred to the portable memory 23. In yet another example, the game outcomes may be provided electronically, such as by electronic mail or the like, to the portable memory 23.

FIG. 5F is a flowchart of a subscription routine 300 which may be stored in the memory of the network controller 140 and/or the purchase controller 120. The subscription routine 300 may be based on an existing subscription or account previously established by the player. The subscription may be established during a visit to a casino, over the telephone, through postal or couriered mail delivery, electronic mail or an Internet website, for example. During the subscription process, the player may designate subscription options, and may be able to subsequently alter the subscription options. In addition, the network computer 22 and/or the purchase unit 21 may impose game limitations during the subscription process. The subscription routine 300 may be performed on a reoccurring basis, such as weekly, monthly, bimonthly, etc. according to the player's subscription.

Referring to FIG. 5F, the subscription routine 300 may begin operation at block 301 during which the player's subscription options may be read. The subscription options may relate to any player-specified options such as games, number of game plays, player preferences or wager denominations, for example. The subscription options may be stored in a memory of the network computer 23 or in a memory of the purchase unit 21 as data relating to the player. In addition to reading player-specified subscription options, the subscription options may include suggested options based on an analysis of the player's demographics, gaming habits and preferences. At block 302, game limitations may be read. The game limitations may include the game limitations disclosed above, including, but not limited to, wager amounts, games, maximum allowed losses per day or per session, wager denominations, gaming device or gaming locations. For example, the gaming limitations may limit the player to using the game outcomes on a particular personal electronic device, only using the game outcomes in the player's home, limiting the player's losses, etc.

The subscription routine 300 may generate game outcomes at block 303 based on the subscription options and game limitations read from blocks 301, 302 respectively. As with the example above, the game outcomes may be seed values used by random number generators as starting values for a random number sequence. The resulting random number may be associated with an outcome, which may or may not result in an associated value payout. The game outcomes, game limitations, etc. may be stored in a data file, such as the data file 160 disclosed above. The game outcomes, game limitations or any other data may be encrypted or otherwise protected from unauthorized access at block 304. The game outcomes may be protected in accordance with a security measure agreed upon by the player during the initial subscription process. For example, the player may have been provided with a passcode, or other personal identification such as biometric identification, to prevent unauthorized use of the game outcomes. Additionally, the game outcomes and other data on the portable memory may be encrypted and/or write-protected to prevent unauthorized manipulation of the data. A decryption key and/or passcode decryption may be known only to the casino, or other game outcome provider. As mentioned above, asymmetric encryption may be utilized. A hash function utilizing the data relating to the game outcomes or any other data stored in the data file 160 or on the portable memory 23 may result in a unique signature. The same hash function utilizing altered data may produce a different signature, thereby indicating unauthorized manipulation of the data. The security measures may be applied accordingly at block 304.

The game outcomes and any other data may be uploaded or otherwise delivered to the portable memory 23 at block 305. The game outcomes may be provided by electronic mail, through an Internet website, or on a disposable memory via a postal or courier delivery service. The game outcomes may be transferred to the portable memory 23 by opening the electronic mail, visiting the website or loading the disposable memory, and downloading the game outcomes, game limitations, etc. to the portable memory 23. Once the game outcomes have been delivered or sent off for delivery, the subscription routine 300 may transmit purchase data to the network computer 22. As above, the purchase data may relate to the player's identity, the player's financial accounts, the game outcomes, the value amount, the selected game options, the game limitations or a timestamp, for example.

Although not shown in FIG. 5F, the subscription process may further include automatically withdrawing an initial value amount from the player's account. Alternatively, the player may provide payment on a reoccurring basis according to the subscription, the receipt of which may trigger the execution of the subscription routine 300. In addition, although the game routine(s) and random number generator(s) may be provided to the player during the initial subscription process and stored on the portable memory 23 or personal electronic device, the subscription routine 300 may provide the game routine(s) and random number generator(s) with the game outcomes. The game routine(s) and/or the random number generator(s) may be protected from unauthorized access by the player.

FIG. 5G is an example of a remote main operating routine 310 which may be performed by a controller 100 of the personal electronic device or by the portable memory controller 150. The routine 310 may be provided as computer program instructions from the network computer 22 or the purchase unit 21 during the initial subscription process. Game routines and/or random number generators relating to particular games may be read from the portable memory 23 and used during the routine 310. The routine 310 may also be provided as computer program instructions from another gaming unit 20, such as a casino gaming unit, following a previous gaming session using the portable memory 23 thereby allowing the player to continue using the game outcomes at a location other than a casino. Although the routine 310 is similar to the main operating routine 206b disclosed with respect to FIG. 5C, it should be understood that the routine 310 may include multiple game routines similar to the main operating routine 206a disclosed with respect to FIG. 5B.

Referring to FIG. 5G, the routine 310 may being operation at block 311 during which the routine 310 may determine if the portable memory 23 has been communicatively coupled with a personal electronic device. If so, a verification routine 312 performed to verify and authenticate the player's identity and limitations on use of the game outcomes. The verification routine 312 may be the verification routine 222 disclosed above. Once a player's identity has been verified and authenticated, a game display may be generated on a display unit of the personal electronic device at block 313. The game display generated at block 313 may include, for example, an image of the casino game that may be played on the personal electronic device. At block 314, the routine 310 may determine if the player requested information concerning the game, in which case the requested information may be displayed at block 315. Block 316 may be used to determine if the player requested initiation of the game, in which case at block 317 a seed value may be decrypted and read from the portable memory 23. If provided, the personal electronic device may download the game routine and random number generator from the portable memory 23. The routine 310 may generate a random number using the seed value at block 318. The game routine 319 may then be performed by associating the random number with an outcome and any resulting value payout. The game routine 319 could be any of the game routines disclosed herein, such as one of the five game routines 227, 228, 229, 230, 231, or another game routine. The game routine 319 may relate to single game play, or the game routine 319 may relate to multiple game plays in which case multiple seed values may be read at block 317 and multiple random numbers may be generated at block 318 for each game play.

After the game routine 319 has been performed to allow the player to play the game, block 320 may be utilized to store the gaming results (i.e., outcomes and/or value payouts) generated during the game routine 319 in a memory of the controller 100 and/or in memory of the portable memory 23. Additional gaming data, such as the gaming data as described above may also be stored at block 320. The gaming data may be stored in the portable memory 23 by updating the data file 160.

After the gaming results, and any additional gaming data, have been stored at block 320, control may return to block 314 to display further information or to play another game. Block 321 may be utilized to determine whether the player wishes to terminate play on the personal electronic device. If the player wishes to stop playing the personal electronic device which wish may be expressed, for example, by selecting a “cash out” button, the controller 100 may dispense value to the player at block 322 based on the gaming results of the gaming routines played by the player. The operation may then return to block 311. If player did not wish to quit as determined at block 321, the operation may return to block 314.

Although the above game routines 227, 228, 229, 230, 231 have been described as allowing a player flexibility regarding gaming selections, such as a wager denomination (e.g., a bet amount) it should be understood that limitations imposed during the subscription routine 300 may result in the game selections not being made available to the player. For example, if the player is limited to a particular game, a game routine that does not correspond to the game limitation may not be executed by the remote main operating routine 310. As another example, a limitation regarding a wager denomination may be read from the portable memory 23 and taken into account when the player inputs a bet amount during one of the game routines 227, 228, 229, 230, 231, which may result in notifying the player of an invalid bet amount or automatically placing the correct bet amount on behalf of the player.

The reconciliation routine 208 may be performed to authenticate the game results, the value payouts and the game outcomes, and to search for discrepancies therein. As above, the reconciliation routine 208 may be performed after each game play, each gaming session or whenever the player wishes to receive monetary funds from a value payout (e.g., electronic transfers to a personal account, cash payouts, etc.). The reconciliation routine 208 may be performed by communicatively coupling the portable memory 23 and/or the personal electronic device to the network computer 22, to provide the network computer 22 with gaming data stored by the portable memory 23 and/or the personal electronic device. The communication between the portable memory 23, the personal electronic device and the network computer 22 may be established via the Internet, an intranet, a dedicated network connection, or a broadband or dial-up connection, for example.

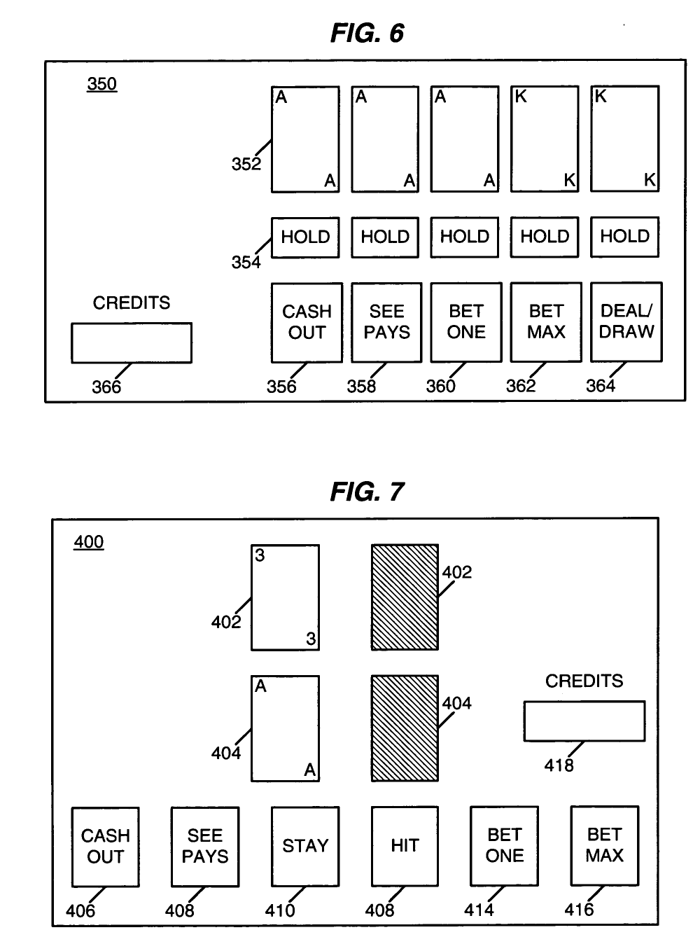

Video Poker

Where the gaming unit 20 is designed to facilitate play of a video poker game, the display unit 70 may comprise a video display unit. FIG. 6 is an exemplary display 350 that may be shown on the display unit 70 during performance of the video poker routine 227 shown schematically in FIG. 5B. Referring to FIG. 6, the display 350 may include video images 352 of a plurality of playing cards representing the player's hand, such as five cards. To allow the player to control the play of the video poker game, a plurality of player-selectable buttons may be displayed. The buttons may include a “Hold” button 354 disposed directly below each of the playing card images 352, a “Cash Out” button 356, a “See Pays” button 358, a “Bet One Credit” button 360, a “Bet Max Credits” button 362, and a “Deal/Draw” button 364. The display 350 may also include an area 366 in which the number of remaining credits or value is displayed. If the display unit 70 is provided with a touch-sensitive screen, the buttons 354, 356, 358, 360, 362, 364 may form part of the video display 350. Alternatively, one or more of those buttons may be provided as part of a control panel that is provided separately from the display unit 70.

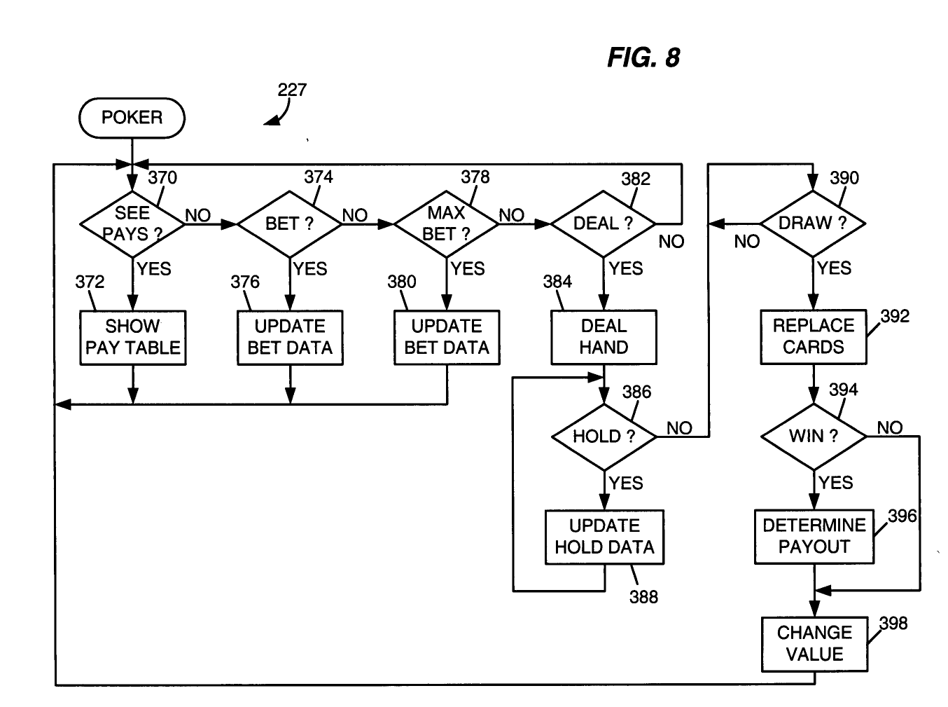

FIG. 8 is a flowchart of the video poker routine 227 shown schematically in FIG. 5B. Referring to FIG. 8, at block 370, the routine may determine whether the player has requested payout information, such as by activating the “See Pays” button 358, in which case at block 372 the routine may cause one or more pay tables to be displayed on the display unit 70. At block 374, the routine may determine whether the player has made a bet, such as by pressing the “Bet One Credit” button 360, in which case at block 376 bet data corresponding to the bet made by the player may be stored in the memory of the portable memory 23 and in the memory of the controller 100. At block 378, the routine may determine whether the player has pressed the “Bet Max Credits” button 362, in which case at block 380 bet data corresponding to the maximum allowable bet may be stored in the memory of the portable memory 23 and in the memory of the controller 100.

At block 382, the routine may determine if the player desires a new hand to be dealt, which may be determined by detecting if the “Deal/Draw” button 364 was activated after a wager was made. In that case, at block 384 a video poker hand may be “dealt” by causing the display unit 70 to generate the playing card images 352. The cards displayed in the video poker hand may be randomly determined based on a seed value read from the portable memory 23. After the hand is dealt, at block 386 the routine may determine if any of the “Hold” buttons 354 have been activated by the player, in which case data regarding which of the playing card images 352 are to be “held” may be stored in the portable memory 23 and may be stored in the controller 100 at block 388. If the “Deal/Draw” button 364 is activated again as determined at block 390, each of the playing card images 352 that was not “held” may be caused to disappear from the video display 350 and to be replaced by a new, randomly selected, playing card image 352 at block 392, which may be selected by a random number generator using the seed value as a starting value for a random number sequence.

At block 394, the routine may determine whether the poker hand represented by the playing card images 352 currently displayed is a winner. That determination may be made by comparing data representing the currently displayed poker hand with data representing all possible winning hands, which may be stored in the memory of the controller 100. If there is a winning hand, a payout value corresponding to the winning hand may be determined at block 396 and stored in the memory of the portable memory 23 and in the memory of the controller 100. At block 398, the player's cumulative value or number of credits may be updated by subtracting the bet made by the player and adding, if the hand was a winner, the payout value determined at block 396. The cumulative value or number of credits may also be displayed in the display area 366 (FIG. 6).

Although the video poker routine 227 is described above in connection with a single poker hand of five cards, the routine 227 may be modified to allow other versions of poker to be played. For example, seven card poker may be played, or stud poker may be played. Alternatively, multiple poker hands may be simultaneously played. In that case, the game may begin by dealing a single poker hand, and the player may be allowed to hold certain cards. After deciding which cards to hold, the held cards may be duplicated in a plurality of different poker hands, with the remaining cards for each of those poker hands being randomly determined.

Video Blackjack

Where the gaming unit 20 is designed to facilitate play of a video blackjack game, the display unit 70 may comprise a video display unit. FIG. 7 is an exemplary display 400 that may be shown on the display unit 70 during performance of the video blackjack routine 228 shown schematically in FIG. 5B. Referring to FIG. 7, the display 400 may include video images 402 of a pair of playing cards representing a dealer's hand, with one of the cards shown face up and the other card being shown face down, and video images 404 of a pair of playing cards representing a player's hand, with both the cards shown face up. The “dealer” may be the gaming unit 20.

To allow the player to control the play of the video blackjack game, a plurality of player-selectable buttons may be displayed. The buttons may include a “Cash Out” button 406, a “See Pays” button 408, a “Stay” button 410, a “Hit” button 412, a “Bet One Credit” button 414, and a “Bet Max Credits” button 416. The display 400 may also include an area 418 in which the number of remaining credits or value is displayed. If the display unit 70 is provided with a touch-sensitive screen, the buttons 406, 408, 410, 412, 414, 416 may form part of the video display 400. Alternatively, one or more of those buttons may be provided as part of a control panel that is provided separately from the display unit 70.

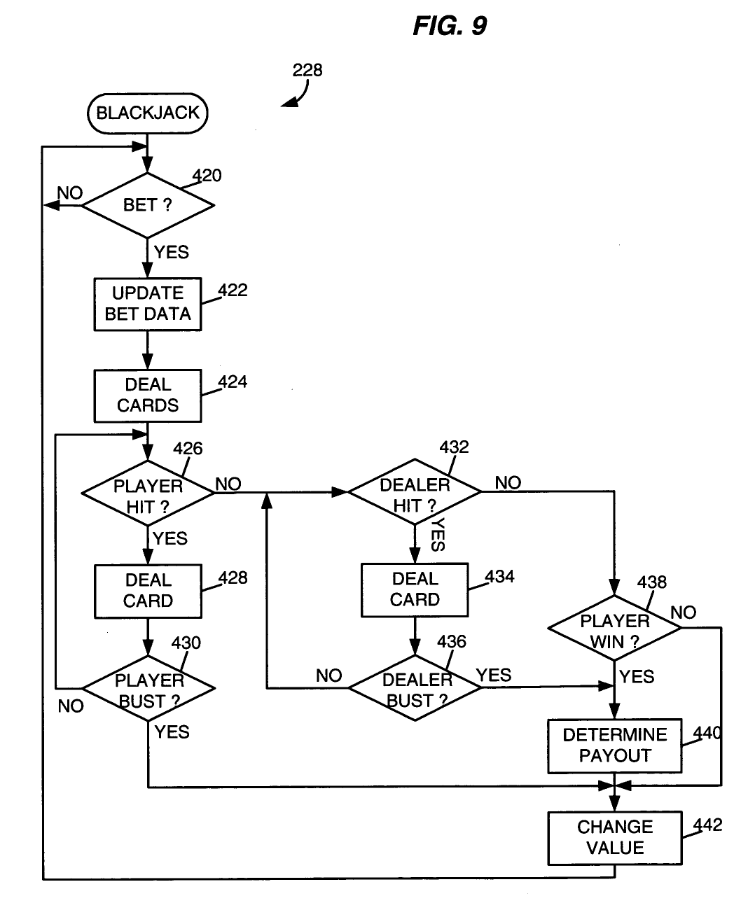

FIG. 9 is a flowchart of the video blackjack routine 228 shown schematically in FIG. 5B. Referring to FIG. 9, the video blackjack routine 228 may begin at block 420 where it may determine whether a bet has been made by the player. That may be determined, for example, by detecting the activation of either the “Bet One Credit” button 414 or the “Bet Max Credits” button 416. At block 422, bet data corresponding to the bet made at block 420 may be stored in the memory of the portable memory 23 and in the memory of the controller 100. At block 424, a dealer's hand and a player's hand may be “dealt” by making the playing card images 402, 404 appear on the display unit 70. The playing cards may be randomly generated using a seed value read from the portable memory 23.

At block 426, the player may be allowed to be “hit,” in which case at block 428 another card may be randomly dealt to the player's hand by making another playing card image 404 appear in the display 400. Player decisions regarding whether to “hit” or to “stay” may be stored in the memory of the portable memory 23 and in the memory of the controller 100. The new card may be randomly generated based on the seed value read from the portable memory 23. If the player is hit, block 430 may determine if the player has “bust,” or exceeded 21. If the player has not bust, blocks 426 and 428 may be performed again to allow the player to be hit again. The cards and the determination may be stored in the memory of the portable memory 23 and in the memory of the controller 100.

If the player decides not to hit, at block 432 the routine may determine whether the dealer should be hit. Whether the dealer hits may be determined in accordance with predetermined rules, such as the dealer always hit if the dealer's hand totals 15 or less. If the dealer hits, at block 434 the dealer's hand may be randomly dealt another card based on the seed value read from the portable memory 23 by making another playing card image 402 appear in the display 400. At block 436 the routine may determine whether the dealer has bust. If the dealer has not bust, blocks 432, 434 may be performed again to allow the dealer to be hit again.

If the dealer does not hit, at block 436 the outcome of the blackjack game and a corresponding payout may be determined based on, for example, whether the player or the dealer has the higher hand that does not exceed 21. If the player has a winning hand, a payout value corresponding to the winning hand may be determined at block 440 and stored in the memory of the portable memory 23 and in the memory of the controller 100. At block 442, the player's cumulative value or number of credits may be updated by subtracting the bet made by the player and adding, if the player won, the payout value determined at block 440 and stored in the memory of the portable memory 23 and in the memory of the controller 100. The cumulative value or number of credits may also be displayed in the display area 418 (FIG. 7).

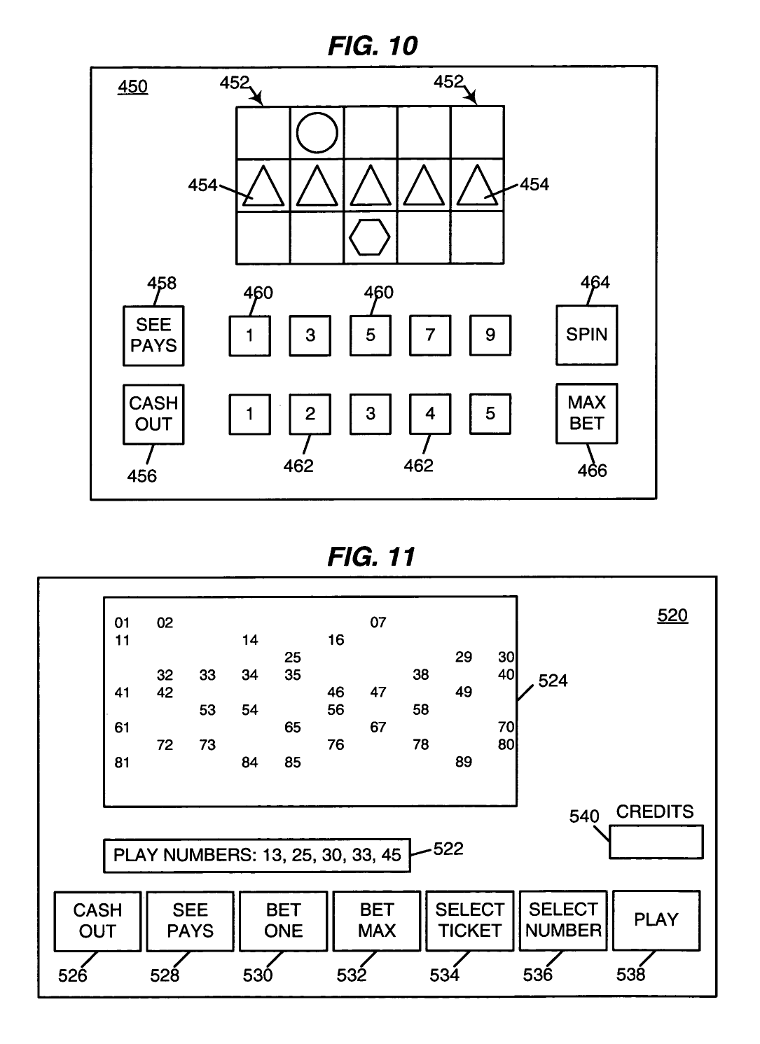

Slots

Where the gaming unit 20 is designed to facilitate play of a video slots game, the display unit 70 may comprise a video display unit. FIG. 10 is an exemplary display 450 that may be shown on the display unit 70 during performance of the slots routine 229 shown schematically in FIG. 5B. Referring to FIG. 10, the display 450 may include video images 452 of a plurality of slot machine reels, each of the reels having a plurality of reel symbols 454 associated therewith. Although the display 450 shows five reel images 452, each of which may have three reel symbols 454 that are visible at a time, other reel configurations could be utilized.

To allow the player to control the play of the slots game, a plurality of player-selectable buttons may be displayed. The buttons may include a “Cash Out” button 456, a “See Pays” button 458, a plurality of payline-selection buttons 460 each of which allows the player to select a different number of paylines prior to “spinning” the reels, a plurality of bet-selection buttons 462 each of which allows a player to specify a wager amount for each payline selected, a “Spin” button 464, and a “Max Bet” button 466 to allow a player to make the maximum wager allowable.

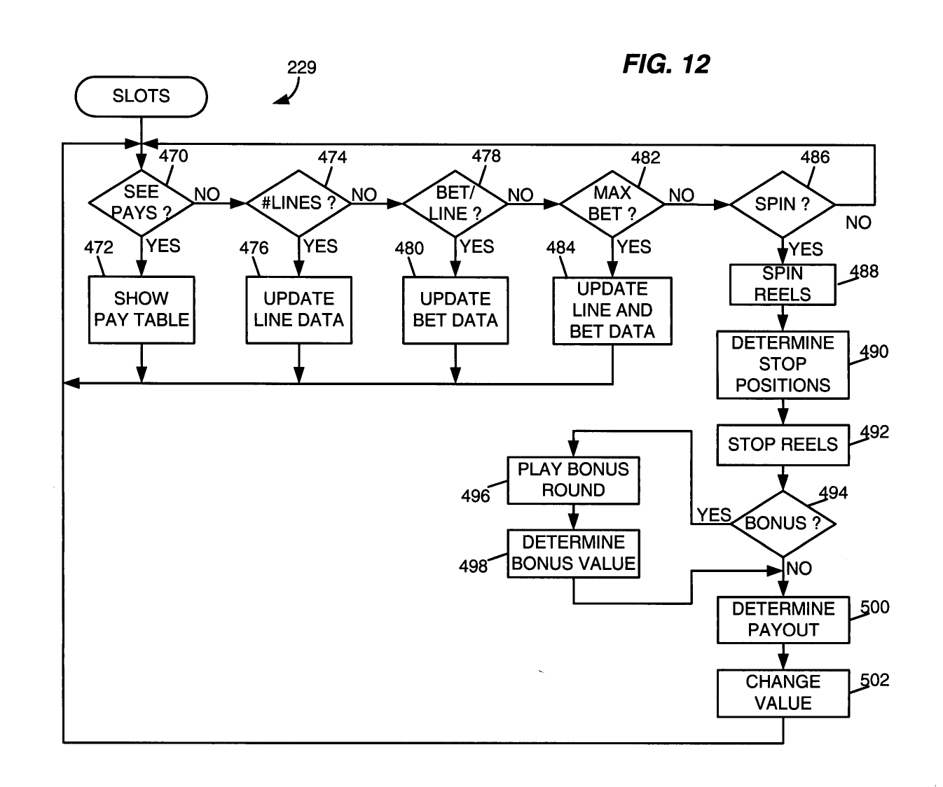

FIG. 12 is a flowchart of the slots routine 229 shown schematically in FIG. 10. Referring to FIG. 12, at block 470, the routine may determine whether the player has requested payout information, such as by activating the “See Pays” button 458, in which case at block 472 the routine may cause one or more pay tables to be displayed on the display unit 70. At block 474, the routine may determine whether the player has pressed one of the payline-selection buttons 460, in which case at block 476 data corresponding to the number of paylines selected by the player may be stored in the memory of the portable memory 23 and in the memory of the controller 100. At block 478, the routine may determine whether the player has pressed one of the bet-selection buttons 462, in which case at block 480 data corresponding to the amount bet per payline may be stored in the memory of the portable memory 23 and in the memory of the controller 100. At block 482, the routine may determine whether the player has pressed the “Max Bet” button 466, in which case at block 484 bet data (which may include both payline data and bet-per-payline data) corresponding to the maximum allowable bet may be stored in the memory of the portable memory 23 and in the memory of the controller 100.

If the “Spin” button 464 has been activated by the player as determined at block 486, at block 488 the routine may cause the slot machine reel images 452 to begin “spinning” so as to simulate the appearance of a plurality of spinning mechanical slot machine reels. At block 490, the routine may randomly determine the positions at which the slot machine reel images will stop, or the particular symbol images 454 that will be displayed when the reel images 452 stop spinning. The stop positions may be randomly determined based on a seed value read from the portable memory 23. At block 492, the routine may stop the reel images 452 from spinning by displaying stationary reel images 452 and images of three symbols 454 for each stopped reel image 452. The virtual reels may be stopped from left to right, from the perspective of the player, or in any other manner or sequence. The stop positions may be stored in the memory of the portable memory 23 and in the memory of the controller 100.

The routine may provide for the possibility of a bonus game or round if certain conditions are met, such as the display in the stopped reel images 452 of a particular symbol 454. If there is such a bonus condition as determined at block 494, the routine may proceed to block 496 where a bonus round may be played. The bonus round may be a different game than slots, and many other types of bonus games could be provided. If the player wins the bonus round, or receives additional credits or points in the bonus round, a bonus value may be determined at block 498. A payout value corresponding to outcome of the slots game and/or the bonus round may be determined at block 500 and stored in the memory of the portable memory 23 and in the memory of the controller 100. At block 502, the player's cumulative value or number of credits may be updated stored in the memory of the portable memory 23 and in the memory of the controller 100 by subtracting the bet made by the player and adding, if the slot game and/or bonus round was a winner, the payout value determined at block 500.

Although the above routine has been described as a virtual slot machine routine in which slot machine reels are represented as images on the display unit 70, actual slot machine reels that are capable of being spun may be utilized instead, in which case the display unit 70 could be provided in the form of a plurality of mechanical reels that are rotatable, each of the reels having a plurality of reel images disposed thereon.

Video Keno

Where the gaming unit 20 is designed to facilitate play of a video keno game, the display unit 70 may comprise a video display unit. FIG. 11 is an exemplary display 520 that may be shown on the display unit 70 during performance of the video keno routine 230 shown schematically in FIG. 5B. Referring to FIG. 11, the display 520 may include a video image 522 of a plurality of numbers that were selected by the player prior to the start of a keno game and a video image 524 of a plurality of numbers randomly selected during the keno game. The randomly selected numbers may be displayed in a grid pattern.

To allow the player to control the play of the keno game, a plurality of player-selectable buttons may be displayed. The buttons may include a “Cash Out” button 526, a “See Pays” button 528, a “Bet One Credit” button 530, a “Bet Max Credits” button 532, a “Select Ticket” button 534, a “Select Number” button 536, and a “Play” button 538. The display 520 may also include an area 540 in which the number of remaining credits or value is displayed. If the display unit 70 is provided with a touch-sensitive screen, the buttons may form part of the video display 520. Alternatively, one or more of those buttons may be provided as part of a control panel that is provided separately from the display unit 70.

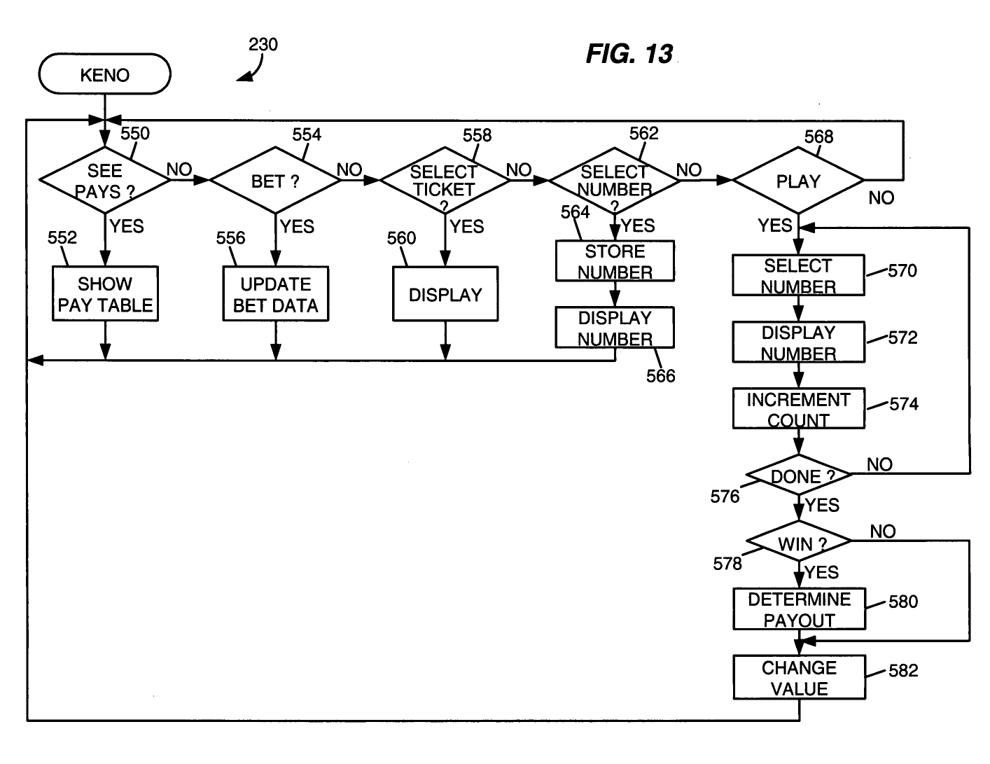

FIG. 13 is a flowchart of the video keno routine 230 shown schematically in FIG. 5B. The keno routine 230 may be utilized in connection with a single gaming unit 20 where a single player is playing a keno game, or the keno routine 230 may be utilized in connection with multiple gaming units 20 where multiple players are playing a single keno game. In the latter case, one or more of the acts described below may be performed either by the controller 100 in each gaming unit or by one of the network computer 22, 32 to which multiple gaming units 20 are operatively connected.

Referring to FIG. 13, at block 550, the routine may determine whether the player has requested payout information, such as by activating the “See Pays” button 528, in which case at block 552 the routine may cause one or more pay tables to be displayed on the display unit 70. At block 554, the routine may determine whether the player has made a bet, such as by having pressed the “Bet One Credit” button 530 or the “Bet Max Credits” button 532, in which case at block 556 bet data corresponding to the bet made by the player may be stored in the memory of the portable memory 23 and in the memory of the controller 100. After the player has made a wager, at block 558 the player may select a keno ticket, and at block 560 the ticket may be displayed on the display 520. At block 562, the player may select one or more game numbers, which may be within a range set by the casino. After being selected, the player's game numbers may be stored in the memory of the portable memory 23 and in the memory of the controller 100 at block 564 and may be included in the image 522 on the display 520 at block 566. After a certain amount of time, the keno game may be closed to additional players (where a number of players are playing a single keno game using multiple gambling units 20).

If play of the keno game is to begin as determined at block 568, at block 570 a game number within a range set by the casino may be randomly selected either by the controller 100 or a central computer operatively connected to the controller, such as one of the network computers 22, 32. The game number may be randomly selected based on a seed value read from the portable memory 23, and the game number may be stored in the memory of the portable memory 23 and in the memory of the controller 100. At block 572, the randomly selected game number may be displayed on the display unit 70 and the display units 70 of other gaming units 20 (if any) which are involved in the same keno game. At block 574, the controller 100 (or the central computer noted above) may increment a count which keeps track of how many game numbers have been selected at block 570.

At block 576, the controller 100 (or one of the network computers 22, 32) may determine whether a maximum number of game numbers within the range have been randomly selected. If not, another game number may be randomly selected at block 570. If the maximum number of game numbers has been selected, at block 578 the controller 100 (or a central computer) may determine whether there are a sufficient number of matches between the game numbers selected by the player and the game numbers selected at block 570 to cause the player to win. The number of matches may depend on how many numbers the player selected and the particular keno rules being used.

If there are a sufficient number of matches, a payout may be determined at block 580 to compensate the player for winning the game and stored in the memory of the portable memory 23 and in the memory of the controller 100. The payout may depend on the number of matches between the game numbers selected by the player and the game numbers randomly selected at block 570. At block 582, the player's cumulative value or number of credits may be updated by subtracting the bet made by the player and adding, if the keno game was won, the payout value determined at block 580 and stored in the memory of the portable memory 23 and in the memory of the controller 100. The cumulative value or number of credits may also be displayed in the display area 540 (FIG. 11).

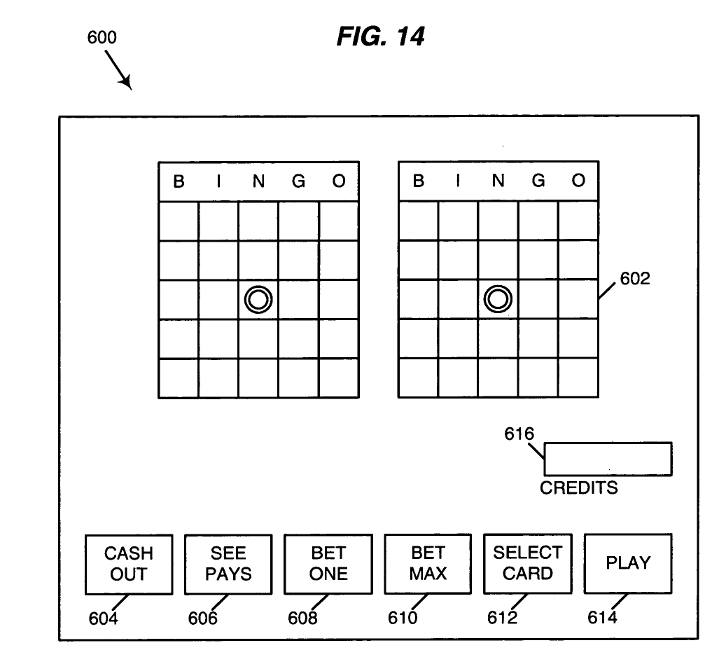

Video Bingo

Where the gaming unit 20 is designed to facilitate play of a video bingo game, the display unit 70 may comprise a video display unit. FIG. 14 is an exemplary display 600 that may be shown on the display unit 70 during performance of the video bingo routine 231 shown schematically in FIG. 5B. Referring to FIG. 14, the display 600 may include one or more video images 602 of a bingo card and images of the bingo numbers selected during the game. The bingo card images 602 may have a grid pattern.

To allow the player to control the play of the bingo game, a plurality of player-selectable buttons may be displayed. The buttons may include a “Cash Out” button 604, a “See Pays” button 606, a “Bet One Credit” button 608, a “Bet Max Credits” button 610, a “Select Card” button 612, and a “Play” button 614. The display 600 may also include an area 616 in which the number of remaining credits or value is displayed. If the display unit 70 is provided with a touch-sensitive screen, the buttons may form part of the video display 600. Alternatively, one or more of those buttons may be provided as part of a control panel that is provided separately from the display unit 70.

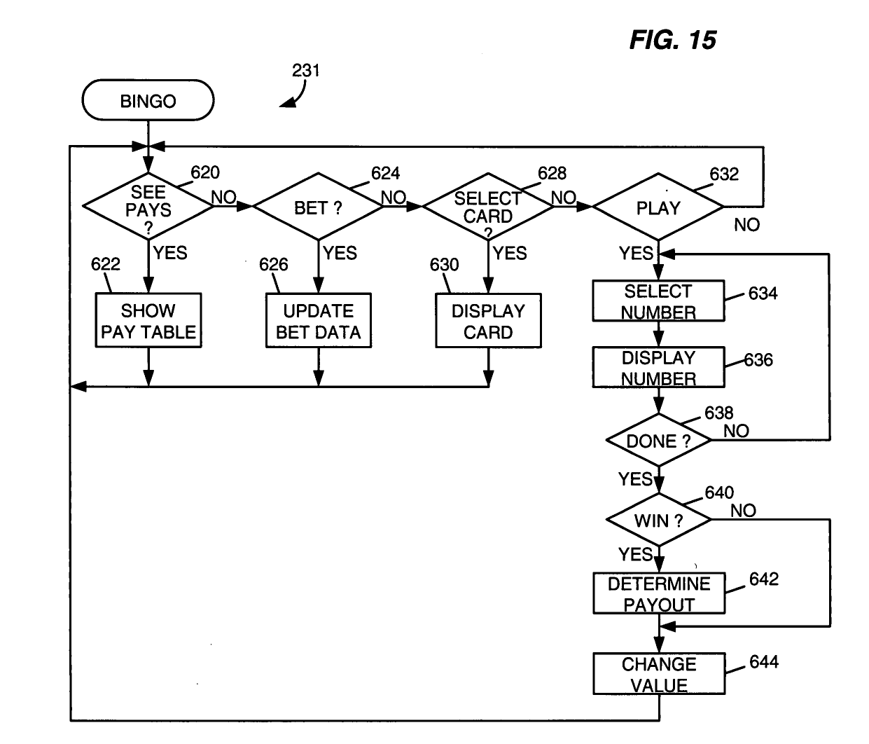

FIG. 15 is a flowchart of the video bingo routine 231 shown schematically in FIG. 5B. The bingo routine 231 may be utilized in connection with a single gaming unit 20 where a single player is playing a bingo game, or the bingo routine 231 may be utilized in connection with multiple gaming units 20 where multiple players are playing a single bingo game. In the latter case, one or more of the acts described below may be performed either by the controller 100 in each gaming unit 20 or by one of the network computers 22, 32 to which multiple gaming units 20 are operatively connected.

Referring to FIG. 15, at block 620, the routine may determine whether the player has requested payout information, such as by activating the “See Pays” button 606, in which case at block 622 the routine may cause one or more pay tables to be displayed on the display unit 70. At block 624, the routine may determine whether the player has made a bet, such as by having pressed the “Bet One Credit” button 608 or the “Bet Max Credits” button 610, in which case at block 626 bet data corresponding to the bet made by the player may be stored in the memory of the portable memory 23 and in the memory of the controller 100.

After the player has made a wager, at block 628 the player may select a bingo card, which may be generated randomly based on a seed value read from the portable memory 23. The player may select more than one bingo card, and there may be a maximum number of bingo cards that a player may select. After play is to commence as determined at block 632, at block 634 a bingo number may be randomly generated by the controller 100 or a central computer such as one of the network computers 22, 32 based on the seed value. At block 636, the bingo number may be displayed on the display unit 70 and the display units 70 of any other gaming units 20 involved in the bingo game. The bingo card and the bingo numbers may be stored in the memory of the portable memory 23 and in the memory of the controller 100.

At block 638, the controller 100 (or a central computer) may determine whether any player has won the bingo game. If no player has won, another bingo number may be randomly selected at block 634. If any player has bingo as determined at block 638, the routine may determine at block 640 whether the player playing that gaming unit 20 was the winner, and the determination may be stored in the memory of the portable memory 23 and in the memory of the controller 100. If so, at block 642 a payout for the player may be determined and stored in the memory of the portable memory 23 and in the memory of the controller 100. The payout may depend on the number of random numbers that were drawn before there was a winner, the total number of winners (if there was more than one player), and the amount of money that was wagered on the game. At block 644, the player's cumulative value or number of credits may be updated by subtracting the bet made by the player and adding, if the bingo game was won, the payout value determined at block 642, which may be stored in the memory of the portable memory 23 and in the memory of the controller 100. The cumulative value or number of credits may also be displayed in the display area 616 (FIG. 14).

What is claimed is:

1. A gaming system, comprising:
a portable memory apparatus having a plurality of seed values associated with a player identification stored thereon, each of said seed values related to an outcome of a game play;
a plurality of gaming apparatuses, wherein each of said plurality of gaming apparatuses comprise: an input device for receiving and reading said portable memory, a display unit and a controller operatively coupled to said display unit and said input device, said controller comprising a processor and a memory operatively coupled to said processor,
each of said controllers being programmed to read a seed value from said portable memory apparatus,
each of said controllers being programmed to cause said display unit to generate a game display relating to one of the following games: poker, blackjack, slots, keno or bingo,
each of said controllers being programmed to determine an outcome of said game based on said seed value,
each of said controllers being programmed to determine a value payout associated with said outcome of said game.

2. A gaming system as defined in claim 1, wherein each of said seed values comprises a randomly generated seed value.

3. A gaming system as defined in claim 1,
wherein each of said controllers is programmed to generate a random number based on a random number sequence,
wherein said seed value comprises a starting value for said random number sequence,
wherein each of said controllers is programmed to associate said random number with said outcome of said game.

4. A gaming system as defined in claim 1,
wherein each of said controllers is programmed to accept a wager comprising a minimum denomination,
wherein the quantity of said plurality of seeds values stored in said portable memory apparatus is based on the lesser of the minimum denominations.

5. A gaming system as defined in claim 1,
wherein said portable memory apparatus comprises a portable processor and a memory operatively coupled to said portable processor,
wherein said portable memory apparatus is programmed to store said plurality of seed values.

6. A gaming system as defined in claim 5, wherein said portable memory apparatus is programmed to store computer program instructions relating to said game.

7. A gaming system as defined in claim 6, wherein one or more of said controllers are programmed to read said computer program instructions relating to said game from said portable memory apparatus.

8. A gaming system as defined in claim 6, wherein one or more of said controllers are programmed to transmit said computer program instructions relating to said game to said portable memory apparatus.

9. A gaming system as defined in claim 1, further comprising a purchase controller comprising a purchase processor and a memory operatively coupled to said purchase processor,
wherein said purchase controller is programmed to accept a value amount relating to a guaranteed number of game plays,
wherein said purchase controller is programmed to store said plurality of seed values on said portable memory apparatus, said plurality of seed values relating to said guaranteed number of game plays.

10. A gaming system as defined in claim 9,
wherein said purchase controller is programmed to store game limitation data on said portable memory apparatus, said game limitation data relating to a selection one of the following games: poker, blackjack, slots, keno or bingo,
wherein each of said controllers is programmed to limit a selection of said game according to said game limitation data.

11. A gaming system as defined in claim 9,
wherein said purchase controller is programmed to store denomination data relating to a wager denomination for said game on said portable memory apparatus,
wherein each of said controllers is programmed to limit a wager amount for said game based on said denomination data.

12. A gaming system as defined in claim 9,
wherein said purchase controller is programmed to store location data relating to a gaming location on said portable memory apparatus,
wherein each of said controllers is programmed to read said seed value if said gaming apparatus is located in said gaming location.

13. A gaming system as defined in claim 9,
wherein said purchase controller is programmed to store gaming apparatus data on said portable memory apparatus, said gaming apparatus data relating to use of the portable memory apparatus with a permitted gaming apparatus,
wherein each of said controllers is programmed to read said seed value if said gaming apparatus comprises a permitted gaming apparatus.

14. A gaming system as defined in claim 9, wherein one or more of said gaming apparatuses further comprise said purchase controller.

15. A gaming system as defined in claim 1 further comprising a network computer communicatively coupled to a purchase controller, said first gaming apparatus, said second gaming apparatus and said portable memory apparatus, said network computer comprising a network controller comprising a network processor and a memory operatively coupled to said network processor,
wherein said network controller is programmed to receive said gaming data relating to said game from one or more of said gaming apparatuses,
wherein said network controller is programmed to receive a game outcome relating to said game from said portable memory apparatus,
said network controller being programmed to read an authentic copy of said seed value from a purchase controller used to purchase said seed values,
wherein said network controller is programmed to emulate said game based on said gaming data and said authentic copy of said seed value to determine an emulated outcome of said game,
wherein said network controller is programmed to compare said emulated outcome of said game to said game outcome of said game from said portable memory apparatus.

16. A gaming system as defined in claim 1, wherein one or more of said gaming apparatuses comprise one of the following: a casino gaming unit, a personal digital assistant, a personal computer and a cellular phone.

17. A gaming system as defined in claim 1, wherein said portable memory apparatus comprises one of the following: a removable flash memory, a recordable integrated circuit, a smart card, a personal digital assistant, a laptop computer and a cellular phone.

18. A gaming apparatus for determining outcomes of a wagering game based on game outcome data stored in a portable memory device, the gaming apparatus comprising:
a display unit;
an input device configured to communicatively couple to a portable memory device;
a controller operatively coupled to said display unit and said input device, said controller comprising a processor and a memory operatively coupled to said processor,
said controller being programmed to cause said input device to read game outcome data stored in a portable memory device,
said controller being programmed to determine an outcome based on said game outcome data,
said controller being programmed to display said outcome on said display unit,
said controller being programmed to determine if said outcome comprises a winning outcome,
said controller being programmed to determine a value payout if said outcome comprises a winning outcome,
said controller being programmed to cause said input device to update said portable memory device with data relating to one or more of the following: said outcome or said value payout.

19. A gaming apparatus as defined in claim 18 wherein said display unit comprises a video display unit that is capable of generating video images.

20. A gaming apparatus as defined in claim 19,
wherein said controller is programmed to cause a video image comprising an image of at least five playing cards to be displayed if said game comprises video poker,
wherein said controller is programmed to cause a video image comprising an image of a plurality of simulated slot machine reels to be displayed if said game comprises video slots,
wherein said controller is programmed to cause a video image comprising an image of a plurality of playing cards to be displayed if said game comprises video blackjack,
wherein said controller is programmed to cause a video image comprising an image of a plurality of keno numbers to be displayed if said game comprises video keno,
wherein said controller is programmed to cause a video image comprising an image of a bingo grid to be displayed if said game comprises video bingo.

21. A gaming apparatus as defined in claim 18, wherein said display unit comprises at least one mechanical slot machine reel.

22. A gaming apparatus as defined in claim 18,
wherein said game outcome data relates to a plurality of game outcomes,
wherein said controller is programmed to read a game outcome for each game play requested by a player.

23. A gaming apparatus as defined in claim 22, wherein said controller is programmed to randomly read said game outcome from said plurality of game outcomes.

24. A gaming apparatus as defined in claim 22, wherein said controller is programmed to sequentially read said game outcome from said plurality of game outcomes.

25. A gaming apparatus as defined in claim 22, wherein each of said plurality of game outcomes comprises a randomly generated game outcome.

26. A gaming apparatus as defined in claim 18,
wherein said game outcome data is encrypted,
wherein said controller is programmed to decrypt said game outcome.

27. A gaming apparatus as defined in claim 18, whereby said game outcome data is associated with a signature unique to said game outcome data.

28. A gaming apparatus as defined in claim 18,
wherein said game outcome data comprises a plurality of seed values,
wherein said controller is programmed to generate a random number based on a random number sequence,
wherein a seed value relating to said game outcome comprises a starting value for said random number sequence,
wherein said controller is programmed to associate said random number with said outcome.

29. A gaming apparatus as defined in claim 18, wherein said controller is programmed to read computer program instructions relating to said game from said portable memory apparatus.

30. A gaming apparatus as defined in claim 18, wherein said controller is programmed to transmit computer program instructions relating to a game to said portable memory apparatus.

31. A gaming apparatus as defined in claim 18,
wherein said controller is programmed to read game limitation data relating to a game selection from said portable memory apparatus,
wherein said controller is programmed to limit a selection of a game according to said game limitation data.

32. A gaming apparatus as defined in claim 18,
wherein said controller is programmed to read denomination data relating to a wager denomination from said portable memory apparatus,
wherein said controller is programmed to limit a wager amount for a game according to said denomination data.

33. A gaming apparatus as defined in claim 18,
wherein said controller is programmed to read location data relating to a gaming location from said portable memory apparatus,
wherein said controller is programmed to read said game outcome data if said gaming apparatus is located in said gaming location.

34. A gaming apparatus as defined in claim 18,
wherein said controller is programmed to read game outcome data relating to use of the portable memory apparatus with a permitted gaming apparatus,
wherein said controller is programmed to read said game outcome data if said gaming apparatus comprises a permitted gaming apparatus.

35. A gaming apparatus as defined in claim 18,
wherein said controller is programmed to receive a value amount relating to a guaranteed number of game plays,
wherein said controller is programmed to store said game outcome data on said portable memory apparatus, said game outcome data relating to said guaranteed number of game plays.

36. A gaming system comprising a plurality of gaming apparatuses as defined in claim 18, said gaming apparatuses being interconnected to form a network of gaming apparatuses.

37. A gaming system as defined in claim 36, wherein said gaming apparatuses are interconnected via one of the following: the Internet, an intranet or a dedicated connection.

38. A portable memory apparatus having a computer program stored therein, said computer program being capable of being used in connection with a plurality of gaming apparatuses, said memory comprising:
a memory portion comprising identification data relating to a player identification,
a memory portion comprising game outcome data relating to a plurality of game outcomes associated with said player identification,
a memory portion physically configured in accordance with computer program instructions that would cause the portable memory apparatus to communicatively couple with a gaming apparatus,
a memory portion physically configured in accordance with computer program instructions that would cause the portable memory apparatus to provide a game outcome from said plurality of game outcomes to said gaming apparatus,
a memory portion physically configured in accordance with computer program instructions that would cause the portable memory apparatus to communicatively decouple from said gaming apparatus.

39. A portable memory apparatus as defined in claim 38, wherein said portable memory apparatus additionally comprises a memory portion physically configured in accordance with computer program instructions that would cause the portable memory apparatus to provide a game outcome from said plurality of game outcomes for each game play requested by a player.

40. A portable memory apparatus as defined in claim 38, wherein said portable memory apparatus additionally comprises a memory portion physically configured in accordance with computer program instructions that would cause the gaming apparatus to generate a game display represented one of the following games: poker, blackjack, slots, keno or bingo.

41. A portable memory apparatus as defined in claim 38 wherein said portable memory apparatus additionally comprises a memory portion physically configured in accordance with computer program instructions that would cause the gaming apparatus to determine a value payout associated with said game outcome.

42. A portable memory apparatus as defined in claim 38 wherein said portable memory apparatus additionally comprises a memory portion physically configured in accordance with computer program instructions that would cause the gaming apparatus to randomly select said game outcome from said plurality of game outcomes.

43. A portable memory apparatus as defined in claim 38 wherein said portable memory apparatus additionally comprises a memory portion physically configured in accordance with computer program instructions that would cause the gaming apparatus to sequentially select said game outcome from said plurality of game outcomes.

44. A portable memory apparatus as defined in claim 38 wherein each of said plurality of game outcomes comprises a randomly generated game outcome.

45. A portable memory apparatus as defined in claim 38 wherein said plurality of game outcomes are encrypted.

46. A portable memory apparatus as defined in claim 45 wherein said encryption comprises asymmetric encryption.

47. A portable memory apparatus as defined in claim 38 wherein said plurality of game outcomes comprise a plurality of seed values each relating to a starting value for a random number sequence.

48. A portable memory apparatus as defined in claim 47 wherein said portable memory apparatus additionally comprises:
a memory portion physically configured in accordance with computer program instructions that would cause the gaming apparatus to generate a random number based on said random number sequence,
a memory portion physically configured in accordance with computer program instructions that would cause the gaming apparatus to associate said random number with an outcome of said game.

49. A portable memory apparatus as defined in claim 47 wherein said portable memory apparatus additionally comprises:
a memory portion comprising game limitation data relating to a game selection,
a memory portion physically configured in accordance with computer program instructions that would cause the gaming apparatus to limit a selection of said game according to said game limitation data.

50. A portable memory apparatus as defined in claim 47 wherein said portable memory apparatus additionally comprises:
a memory portion comprising denomination data relating to a wager denomination,
a memory portion physically configured in accordance with computer program instructions that would cause the gaming apparatus to limit a wager amount for said game according to said denomination data.

51. A portable memory apparatus as defined in claim 47 wherein said portable memory apparatus additionally comprises:
a memory portion comprising location data relating to a gaming location,
a memory portion physically configured in accordance with computer program instructions that would cause the gaming apparatus to read said seed value if said gaming apparatus is located in said gaming location.

52. A portable memory apparatus as defined in claim 47 wherein said portable memory apparatus additionally comprises:
a memory portion comprising gaming apparatus data relating to use of the portable memory apparatus with a permitted gaming apparatus,
a memory portion physically configured in accordance with computer program instructions that would cause the gaming apparatus to read said seed value if said gaming apparatus comprises a permitted gaming apparatus.

53. A portable memory apparatus as defined in claim 38 wherein said portable memory apparatus additionally comprises a controller comprising a processor and a memory operatively coupled to said controller.

54. A portable memory apparatus as defined in claim 38 wherein said portable memory apparatus comprises one of the following: a removable flash memory, a recordable integrated circuit, a smart card, a personal digital assistant, a laptop computer and a cellular phone.

55. A game purchasing apparatus, comprising:
a display unit;
a value input device;
a controller operatively coupled to said display unit and said value input device, said controller comprising a processor and a memory operatively coupled to said processor,
said controller being programmed to receive a value amount relating to a plurality of game plays,
said controller being programmed to generate a game outcome for each of said plurality of game plays,
said controller being programmed to associate said plurality of game outcomes with a player identification,
said controller being programmed to store said game outcomes on a portable memory apparatus as game outcome data,
said controller being programmed to communicatively decouple from said portable memory apparatus.

56. A game purchasing apparatus as defined in claim 55, wherein said controller is programmed to store computer program instructions relating to a game on said portable memory apparatus.

57. A game purchasing apparatus as defined in claim 55,
wherein said controller is programmed to read a game outcome from said game outcome data,
wherein said controller is programmed to determine an outcome based on said game outcome data,
wherein said controller is programmed to display said outcome on said display unit,
wherein said controller is programmed to determine if said outcome comprises a winning outcome,
wherein said controller is programmed to determine a value payout if said outcome comprises a winning outcome.

58. A game purchasing apparatus as defined in claim 55, wherein said purchase controller is programmed to store game limitation data on said portable memory apparatus, said game limitation data relating to a selection of one of the following games: poker, blackjack, slots, keno or bingo.

59. A game purchasing apparatus as defined in claim 55, wherein said purchase controller is programmed to store denomination data on said portable memory, said denomination data relating to a limitation on a wager amount.

60. A game purchasing apparatus as defined in claim 55, wherein said purchase controller is programmed to store location data on said portable memory, said location data relating to a limitation on use of the portable memory within a defined location.

61. A game purchasing apparatus as defined in claim 55, wherein said purchase controller is programmed to store gaming apparatus data on said portable memory apparatus, said gaming apparatus data relating to a limitation on use of the portable memory with a permitted gaming apparatus.

62. A method for providing a wagering game wherein a player may pre-purchase outcomes for the wagering game before playing the wagering game, the method comprising:
providing a portable memory apparatus;
providing a game outcome purchasing apparatus adapted to communicatively couple to said portable memory apparatus;
storing game outcome data relating to one or more game outcomes on said portable memory apparatus in response to a request from a player to purchase at least one game outcome;
dispensing said portable memory apparatus after said game outcome data has been stored thereon;
providing a gaming apparatus adapted to communicatively couple to said portable memory apparatus;
determining an outcome for a wagering game based on said game outcome data read by said gaming apparatus from said portable memory apparatus;
determining whether said outcome comprises a winning outcome; and
determining a value payout corresponding to a winning outcome if said outcome comprises a winning outcome.

63. A method as defined in claim 62 further comprising accepting a value amount relating to a guaranteed number of game plays, wherein said game outcome data relates to said guaranteed number of game plays.

64. A method as defined in claim 62 further comprising:
storing game limitation data relating to a wagering game selection on said portable memory apparatus; and
limiting a selection of said wagering game according to said game limitation data.

65. A method as defined in claim 62 further comprising:
storing denomination data relating to a wager denomination for said wagering game on said portable memory apparatus; and
limiting a wager amount for said wagering game based on said denomination data.

66. A method as defined in claim 62 further comprising:
storing location data relating to a gaming location on said portable memory apparatus; and
determining said outcome if said gaming apparatus is located in said gaming location.

67. A method as defined in claim 62 further comprising:
storing permitted gaming apparatus data on said portable memory apparatus;
determining said outcome if said gaming apparatus comprises a permitted gaming apparatus.

68. A method as defined in claim 62 further comprising randomly generating said game outcome data.

69. A method as defined in claim 62 further comprising associating said game outcome data with an identification of said player.

70. A method as defined in claim 62 further comprising encrypting said game outcome data on said portable memory apparatus.

71. A method as defined in claim 70, wherein encrypting said game outcome data comprises asymmetrically encrypting said game outcome data.

72. A method as defined in claim 62 further comprising decrypting a game outcome from said one or more game outcomes.

73. A method as defined in claim 62 further comprising:
generating a signature unique to said game outcome data; and
storing said unique signature on said portable memory apparatus.

74. A method as defined in claim 62 further comprising:
randomly reading a game outcome from said one or more game outcomes; and
wherein determining said outcome comprises determining said outcome for said wagering game based on said randomly read game outcome.

75. A method as defined in claim 62 further comprising:
sequentially reading a game outcome from said one or more game outcomes; and
wherein determining said outcome comprises determining said outcome for said wagering game based on said sequentially read game outcome.

76. A method as defined in claim 62, wherein said game outcome data comprises one or more seed values, each seed value relating to a starting value for a random number sequence, the method further comprising:
generating a random number based on a random number sequence and based on a seed value; and
associating said random number with said outcome.

77. A method as defined in claim 62, further comprising:
storing computer program instructions relating to said wagering game on said portable memory apparatus;
reading said computer program instructions from said portable memory apparatus; and
causing a game display relating to said wagering game to be generated in response to said computer program instructions.

78. A method as defined in claim 62 further comprising updating said portable memory apparatus with one or more of the following: said outcome or said value payout.

79. A method as defined in claim 78 further comprising:
providing a network computer adapted to communicatively couple to said game outcome purchasing apparatus, said portable memory apparatus and said gaming apparatus,
reading gaming data relating to said wagering game from said gaming apparatus;
reading said outcome relating to said wagering game from said portable memory apparatus;
reading an authentic copy of said one or more game outcomes from said game outcome purchasing apparatus;
emulating said wagering game based on said gaming data and said authentic copy of said one or more game outcomes to determine an emulated outcome of said wagering game; and
comparing said emulated outcome of said wagering game to said outcome of said wagering game from said portable memory apparatus.

80. A method as defined in claim 62, wherein providing said portable memory apparatus comprises providing said portable memory apparatus on a reoccurring basis.

81. A method as defined in claim 62, wherein storing said game outcome data on said portable memory apparatus comprises storing game outcome data relating to one or more game outcomes on said portable memory apparatus in response to a request from a player to purchase at least one game outcome on a reoccurring basis.

82. A method as defined in claim 62, wherein said gaming apparatus comprises a personal electronic device of said player.
